(19) United States
(12) Patent Application Publication
(10) Pub. No.: US 2026/0211214 A1
(43) Pub. Date: Jul. 23, 2026

(54) OPTICAL PHOTOGRAPHY LENS SYSTEM, IMAGE CAPTURING UNIT AND ELECTRONIC DEVICE

(71) Applicant: LARGAN PRECISION CO., LTD., Taichung City (TW)

(72) Inventors: Yu-Chun KE, Taichung City (TW); Yu-Han SHIH, Taichung City (TW)

(73) Assignee: LARGAN PRECISION CO., LTD., Taichung City (TW)

(21) Appl. No.: 19/202,153

(22) Filed: May 8, 2025

Related U.S. Application Data
(60) Provisional application No. 63/746,699, filed on Jan. 17, 2025.

(30) Foreign Application Priority Data
Feb. 24, 2025 (TW) 114106689

(51) Int. Cl. G02B 13/00; G02B 1/04; G02B 7/02; G02B 9/64; G02B 27/00; G03B 17/12; H04N 23/55

(52) U.S. Cl. CPC G02B 13/0045; G02B 1/041; G02B 7/021; G02B 9/64; G02B 13/0055; G02B 27/0018; G03B 17/12; H04N 23/55

(57) ABSTRACT

An optical photography lens system includes a lens barrel and a plurality of lens elements disposed in the lens barrel. The total number of the plurality of lens elements is six, seven, or eight. Each of the plurality of lens elements has an object-side surface facing toward an object side and an image-side surface facing toward an image side. At least one of the object-side surface and the image-side surface of at least one lens element of the optical photography lens system has at least one inflection point. The optical photography lens system further includes a light-blocking element located in the lens barrel and located on an object side of the first lens element. The lens barrel has a lens-barrel-minimum opening located on an object side of a minimum opening of the light-blocking element.

### RELATED APPLICATIONS

This application claims priority to U.S. Provisional Application 63/746,699, filed on Jan. 17, 2025 and Taiwan Application 114106689, filed on Feb. 24, 2025, which are incorporated by reference herein in its entirety.

### BACKGROUND

### Technical Field

The present disclosure relates to an optical photography lens system, an image capturing unit and an electronic device, more particularly to an optical photography lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical photography lens system includes a lens barrel and a plurality of lens elements disposed in the lens barrel. The total number of the plurality of lens elements is six, seven, or eight. When the total number of the plurality of lens elements is six, the plurality of lens elements are, in order from an object side to an image side along an optical path, a first lens element, a second lens element, a third lens element, a fourth lens element, a fifth lens element and a sixth lens element. When the total number of the plurality of lens elements is seven, the plurality of lens elements are, in order from the object side to the image side along the optical path, the first lens element, the second lens element, the third lens element, the fourth lens element, the fifth lens element, the sixth lens element and a seventh lens element. When the total number of the plurality of lens elements is eight, the plurality of lens elements are, in order from the object side to the image side along the optical path, the first lens element, the second lens element, the third lens element, the fourth lens element, the fifth lens element, the sixth lens element, the seventh lens element and an eighth lens element. Each of the plurality of lens elements has an object-side surface facing toward the object side and an image-side surface facing toward the image side.

Preferably, at least one of the object-side surface and the image-side surface of at least one lens element of the optical photography lens system has at least one inflection point. Preferably, the optical photography lens system further includes a light-blocking element located in the lens barrel and located on an object side of the first lens element. Preferably, the light-blocking element has an object-side surface facing towards the object side, an image-side surface facing towards the image side and a minimum opening located between the object-side surface and the image-side surface of the light-blocking element. Preferably, the lens barrel has a lens-barrel-minimum-opening located on an object side of the minimum opening of the light-blocking element.

When a central thickness of the first lens element is CT1, and a lens thickness of the first lens element in parallel with an optical axis at a maximum effective radius position of the minimum opening of the light-blocking element is ST1, the following condition is preferably satisfied:

1.10<CT1/ST1<3.00.

According to another aspect of the present disclosure, an optical photography lens system includes a lens barrel and seven lens elements disposed in the lens barrel. The seven lens elements are, in order from an object side to an image side along an optical path, a first lens element, a second lens element, a third lens element, a fourth lens element, a fifth lens element, a sixth lens element and a seventh lens element. Each of the seven lens elements has an object-side surface facing toward the object side and an image-side surface facing toward the image side.

Preferably, the first lens element has positive refractive power. Preferably, the object-side surface of the first lens element is convex in paraxial region thereof. Preferably, the seventh lens element has negative refractive power. Preferably, the image-side surface of the seventh lens element is concave in a paraxial region thereof. Preferably, the optical photography lens system further includes a light-blocking element located in the lens barrel and located on an object side of the first lens element. Preferably, the light-blocking element has an object-side surface facing towards the object side, an image-side surface facing towards the image side, and a minimum opening located between the object-side surface and the image-side surface of the light-blocking element. Preferably, the lens barrel has a lens-barrel-minimum-opening located on an object side of the minimum opening of the light-blocking element.

When a central thickness of the first lens element is CT1, and a lens thickness of the first lens element in parallel with an optical axis at a maximum effective radius position of the minimum opening of the light-blocking element is ST1, the following condition is preferably satisfied:

1.30<CT1/ST1<2.60.

According to another aspect of the present disclosure, an image capturing unit includes one of the aforementioned optical photography lens systems and an image sensor, wherein the image sensor is disposed on an image surface of the optical photography lens system.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a perspective view of an image capturing unit according to the 9th embodiment of the present disclosure;

FIG. 18 is a perspective view of an electronic device according to the 10th embodiment of the present disclosure;

FIG. 19 is another perspective view of the electronic device in FIG. 18;

FIG. 20 is a perspective view of an electronic device according to the 11th embodiment of the present disclosure;

FIG. 21 is another perspective view of the electronic device in FIG. 20;

FIG. 22 is a block diagram of the electronic device in FIG. 20;

FIG. 23 is a perspective view of an electronic device according to the 12th embodiment of the present disclosure;

FIG. 24 is a perspective view of an electronic device according to the 13th embodiment of the present disclosure;

FIG. 25 is a schematic view showing configuration relationship between each element in the 1st embodiment of the present disclosure;

FIG. 26 shows a schematic view of inflection points on lens surfaces and critical points on lens surfaces according to the 1st embodiment of the present disclosure;

FIG. 27 shows a schematic view of ET1, ET2, ET5, Ybo, Ys0, Y2R2, Y3R2, Y4R2, Y5R1, Y5R2 and Y6R1 according to the 1st embodiment of the present disclosure; and

FIG. 28 shows a schematic view of Dbs0, DbR1, DbR2, DsR2, ST1, ST6, ST7, SAG2R2, SAG3R1, SAG3R2, SAG4R2 and SAG5R1 according to the 1st embodiment of the present disclosure.

### DETAILED DESCRIPTION

An optical photography lens system includes a lens barrel and a plurality of lens elements.

The lens barrel has a lens-barrel-object-end outer surface that is an annular surface of the lens barrel being closest to an object side and facing towards the object side. Moreover, the lens-barrel-object-end outer surface surrounds an optical axis.

The plurality of lens elements are disposed in the lens barrel. The total number of the plurality of lens elements is six, seven, or eight. When the total number of the plurality of lens elements is six, the plurality of lens elements are, in order from the object side to an image side along an optical path, a first lens element, a second lens element, a third lens element, a fourth lens element, a fifth lens element and a sixth lens element. When the total number of the plurality of lens elements is seven, the plurality of lens elements are, in order from the object side to the image side along the optical path, the first lens element, the second lens element, the third lens element, the fourth lens element, the fifth lens element, the sixth lens element and a seventh lens element. When the total number of the plurality of lens elements is eight, the plurality of lens elements are, in order from the object side to the image side along the optical path, the first lens element, the second lens element, the third lens element, the fourth lens element, the fifth lens element, the sixth lens element, the seventh lens element and an eighth lens element. Moreover, each of the plurality of lens elements has an object-side surface facing toward the object side and an image-side surface facing toward the image side.

The first lens element can have positive refractive power. Therefore, it is favorable for converging light so as to maintain a proper size of the optical photography lens system. The object-side surface of the first lens element can be convex in a paraxial region thereof. Therefore, it is favorable for adjusting the lens shape of the object-side surface and the extent of the refractive power of the first lens element, thereby allowing light from various fields of view uniformly entering the optical photography lens system.

The image-side surface of the second lens element can be concave in a paraxial region thereof. Therefore, it is favorable for adjusting the lens shape of the image-side surface of the second lens element, thereby correcting aberrations such as spherical aberration.

The image-side surface of the fifth lens element can be concave in a paraxial region thereof. Therefore, it is favorable for balancing the convergence and divergence of light at the central region of the optical photography lens system, thereby improving convergence quality.

The sixth lens element can have positive refractive power. Therefore, it is favorable for having light convergence ability of the sixth lens element, thereby miniaturizing the lens. The object-side surface of the sixth lens element can be convex in a paraxial region thereof. Therefore, it is favorable for enhancing the positive refractive power of the sixth lens element so as to reduce the overall size.

When the total number of the plurality of lens elements is seven or eight, the seventh lens element can have negative refractive power. Therefore, it is favorable for reducing the back focal length to prevent an excessive total track length. The object-side surface of the seventh lens element can be concave in a paraxial region thereof. Therefore, it is favorable for assisting in adjustment to the negative refractive power of the seventh lens element, thereby enlarging the image surface and reducing the total track length. The image-side surface of the seventh lens element can be concave in a paraxial region thereof. Therefore, it is favorable for reducing the total track length and also correcting field curvature and distortion.

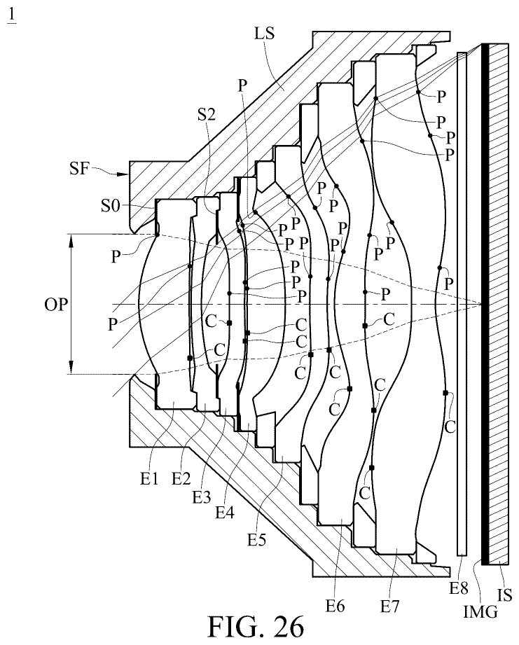

According to the present disclosure, at least one of the object-side surface and the image-side surface of at least one lens element of the optical photography lens system can have at least one inflection point. Therefore, it is favorable for maintaining a miniaturized lens while improving convergence quality of light from various fields of view. The image-side surface of the fifth lens element can have at least one inflection point. Therefore, it is favorable for increasing optical design flexibility and also enhancing the aberration correction ability of the fifth lens element to the peripheral image. Please refer to FIG. 26, which shows a schematic view of inflection points P on the image-side surface of the fifth lens element E5 according to the 1st embodiment of the present disclosure. The abovementioned inflection points P on the image-side surface of the fifth lens element E5, as well as inflection points P on the object-side surface of the first lens element E1, the image-side surface of the first lens element E1, the object-side surface of the third lens element E3, the image-side surface of the third lens element E3, the object-side surface of the fourth lens element E4, the image-side surface of the fourth lens element E4, the object-side surface of the fifth lens element E5, the object-side surface of the sixth lens element E6, the image-side surface of the sixth lens element E6, the object-side surface of the seventh lens element E7 and the image-side surface of the seventh lens element E7 in FIG. 26 are exemplary. Each of lens surfaces in various embodiments of the present disclosure may also have one or more inflection points in an off-axis region thereof.

According to the present disclosure, at least one of the object-side surface and the image-side surface of at least one lens element of the optical photography lens system can have at least one critical point in an off-axis region thereof. Therefore, it is favorable for increasing surface variation at the lens periphery to effectively improve image quality. The object-side surface of the sixth lens element can have at least one critical point in an off-axis region thereof. Therefore, it is favorable for having a certain extent in surface variation at the periphery of the object-side surface of the sixth lens element, thereby increasing illuminance at the peripheral image surface and improving image quality. When the total number of the plurality of lens elements is seven or eight, the image-side surface of the seventh lens element can have at least one critical point in an off-axis region thereof. Therefore, it is favorable for effectively controlling the light angle at the periphery, thereby preventing vignetting at the image periphery and correcting distortion. Please refer to FIG. 26, which shows a schematic view of critical points C on the object-side surface of the sixth lens element E6 and the image-side surface of the seventh lens element E7 according to the 1st embodiment of the present disclosure. The abovementioned critical points C on the object-side surface of the sixth lens element E6 and the image-side surface of the seventh lens element E7, as well as critical points C on the image-side surface of the first lens element E1, the object-side surface of the third lens element E3, the image-side surface of the third lens element E3, the object-side surface of the fourth lens element E4, the object-side surface of the fifth lens element E5, the image-side surface of the fifth lens element E5, the image-side surface of the sixth lens element E6 and the object-side surface of the seventh lens element E7 in FIG. 26 are exemplary. Each of lens surfaces in various embodiments of the present disclosure may also have one or more critical points in an off-axis region thereof.

According to the present disclosure, the optical photography lens system can further include a light-blocking element that can be located in the lens barrel and can be located on an object side of the first lens element. Therefore, it is favorable for preventing reflection of non-imaging light in the lens, thereby improving image quality. Moreover, the light-blocking element can have an object-side surface facing towards the object side, an image-side surface facing towards the image side, a minimum opening located between the object-side surface and the image-side surface of the light-blocking element, and a bore surface connected to and located between the object-side surface and the image-side surface of the light-blocking element. Moreover, the lens barrel can have a lens-barrel-minimum-opening that can be located on an object side of the minimum opening of the light-blocking element. Therefore, it is favorable for blocking high-intensity light at an early stage, such that stray light to be attenuated at a later stage can be easily managed by various stray light suppression means in the lens. Moreover, the minimum opening of the light-blocking element and the lens-barrel-minimum-opening can be circularly symmetrical about the optical axis.

According to the present disclosure, the optical photography lens system can further include another light-blocking element that can be located between the second lens element and the third lens element. Therefore, it is favorable for assisting in preventing generation of stray light, thereby presenting good photography effect.

According to the present disclosure, the lens barrel can be made of plastic material. Therefore, it is favorable for significantly reducing the weight of the optical photography lens system and also increasing manufacturability and mechanical design flexibility.

According to the present disclosure, each of the fifth lens element and the sixth lens element can be made of plastic material. Therefore, it is favorable for increasing manufacturability in aspheric design while reducing manufacturing cost. When the total number of the plurality of lens elements is seven or eight, the seventh lens element can also be made of plastic material.

According to the present disclosure, the light-blocking element or the lens-barrel-minimum-opening that is located on the object side of the first lens element can be served as an aperture of the optical photography lens system, and the present disclosure is not limited thereto.

According to the present disclosure, any light-blocking element, spacers or the lens-barrel-minimum-opening can be served as a stop of the optical photography lens system, and the present disclosure is not limited thereto.

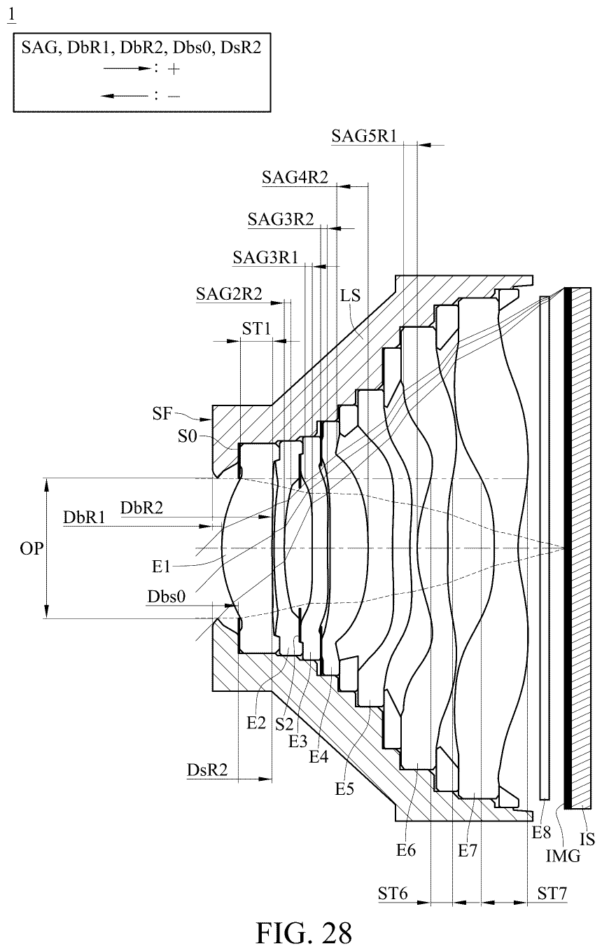

When a displacement in parallel with the optical axis from a most-object-end of the lens barrel to an axial vertex on the object-side surface of the first lens element is DbR1, the following condition can be satisfied: −0.10 mm (millimeters)<DbR1. Therefore, it is favorable for reducing scratching on the lens element and also effectively increasing yield rate of manufacturing to reduce manufacturing cost. Moreover, the following condition can also be satisfied: −0.05 mm<DbR1<0.50 mm. Moreover, the following condition can also be satisfied: 0 mm≤DbR1<0.40 mm. Moreover, the following condition can also be satisfied: 0.01 mm≤DbR1≤0.34 mm. Moreover, the following condition can also be satisfied: 0 mm≤DbR1≤0.28 mm. Please refer to FIG. 28, which shows a schematic view of DbR1 according to the 1st embodiment of the present disclosure. When the direction of the said displacement is facing towards the image side of the optical photography lens system, the value of the said displacement is positive; when the direction of the said displacement is facing towards the object side of the optical photography lens system, the value of the said displacement is negative. In some cases, DbR1 can also be considered as a displacement in parallel with the optical axis from the lens-barrel-object-end outer surface to the axial vertex on the object-side surface of the first lens element.

When a central thickness of the first lens element is CT1, and a lens thickness of the first lens element in parallel with the optical axis at a maximum effective radius position of the minimum opening of the light-blocking element is ST1, the following condition can be satisfied: 1.00<CT1/ST1<3.20. Therefore, it is favorable for effectively controlling the thickness ratio of the central region to the peripheral region of the first lens element so as to maintain stability and manufacturing quality of lens molding. Moreover, the following condition can also be satisfied: 1.10<CT1/ST1<3.00. Moreover, the following condition can also be satisfied: 1.20<CT1/ST1<2.80. Moreover, the following condition can also be satisfied: 1.30<CT1/ST1<2.60. Moreover, the following condition can also be satisfied: 1.40<CT1/ST1<2.50. Moreover, the following condition can also be satisfied: 1.56≤CT1/ST1≤2.95. Please refer to FIG. 28, which shows a schematic view of ST1 according to the 1st embodiment of the present disclosure. In some cases, ST1 can also be considered as a lens thickness of the first lens element in parallel with the optical axis at a maximum effective radius position of the object-side surface of the light-blocking element.

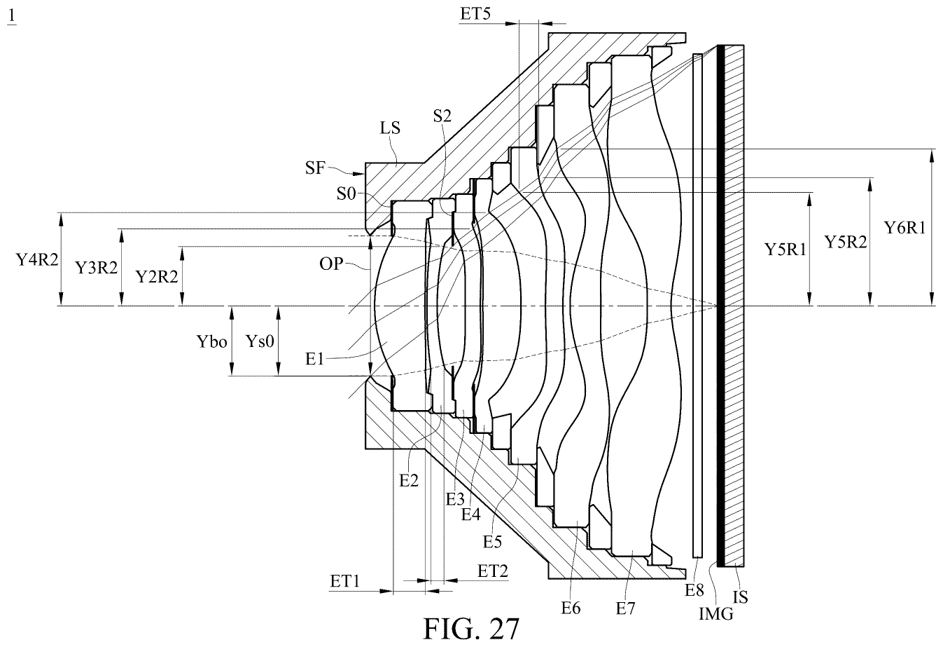

When a displacement in parallel with the optical axis from the most-object-end of the lens barrel to a most-object-end of the light-blocking element is Dbs0, and a maximum effective radius of the minimum opening of the light-blocking element is Ys0, the following condition can be satisfied: 0.15<Dbs0/Ys0<0.80. Therefore, it is favorable for assisting in adjustment to the opening size and the position of the light-blocking element, thereby balancing the deflection at the light incident position. Moreover, the following condition can also be satisfied: 0.20<Dbs0/Ys0<0.75. Moreover, the following condition can also be satisfied: 0.25<Dbs0/Ys0<0.60. Moreover, the following condition can also be satisfied: 0.35≤Dbs0/Ys0≤0.69. Please refer to FIG. 27, which shows a schematic view of Ys0 according to the 1st embodiment of the present disclosure. Please refer to FIG. 28, which shows a schematic view of Dbs0 according to the 1st embodiment of the present disclosure. When the direction of the said displacement is facing towards the image side of the optical photography lens system, the value of the said displacement is positive; when the direction of the said displacement is facing towards the object side of the optical photography lens system, the value of the said displacement is negative. In some cases, Dbs0 can also be considered as a displacement in parallel with the optical axis from the lens-barrel-object-end outer surface to the object-side surface of the light-blocking element. In some cases, Ys0 can also be considered as a maximum effective radius of the object-side surface of the light-blocking element.

When half of a maximum field of view of the optical photography lens system is HFOV, the following condition can be satisfied: 25.0 degrees<HFOV<50.0 degrees. Therefore, it is favorable for enlarging the field of view and correcting aberrations such as distortion due to an overly large field of view. Moreover, the following condition can also be satisfied: 30.0 degrees<HFOV<48.0 degrees. Moreover, the following condition can also be satisfied: 36.4 degrees≤HFOV≤45.3 degrees.

When an Abbe number of the first lens element is V1, and an Abbe number of the second lens element is V2, the following condition can be satisfied: 15.0<V1−V2<52.0. Therefore, it is favorable for controlling the difference in Abbe number between the first lens element and the second lens element, thereby balancing convergence ability to light with different wavelengths and correcting chromatic aberration. Moreover, the following condition can also be satisfied: 20.0<V1−V2<48.0.

When an Abbe number of the third lens element is V3, and an Abbe number of the fourth lens element is V4, the following condition can be satisfied: 25.0<V4−V3<52.0. Therefore, it is favorable for controlling the difference in Abbe number between the third lens element and the fourth lens element, thereby correcting chromatic aberration of the optical photography lens system and assisting in improvement of the color contrast and resolution of images. Moreover, the following condition can also be satisfied: 30.0<V4−V3<48.0.

When an axial distance between the second lens element and the third lens element is T23, and a central thickness of the second lens element is CT2, the following condition can be satisfied: 1.00<T23/CT2<3.20. Therefore, it is favorable for considering the overall design to provide proper accommodation space for other optical element or mechanism. Moreover, the following condition can also be satisfied: 1.30<T23/CT2<3.10. Moreover, the following condition can also be satisfied: 1.60<T23/CT2<3.00. Moreover, the following condition can also be satisfied: 2.00<T23/CT2<2.90.

When the central thickness of the first lens element is CT1, and the central thickness of the second lens element is CT2, the following condition can be satisfied: 0.10<CT2/CT1<0.40. Therefore, it is favorable for reducing surface reflection generated by the first lens element, thereby reducing light spot in images. Moreover, the following condition can also be satisfied: 0.15<CT2/CT1<0.35.

When the central thickness of the first lens element is CT1, and a central thickness of the third lens element is CT3, the following condition can be satisfied: 0.10<CT3/CT1<0.55. Therefore, it is favorable for having a relatively thick central thickness of the first lens element, thereby strengthening the optical photography lens system. Moreover, the following condition can also be satisfied: 0.15<CT3/CT1<0.40.

When the central thickness of the first lens element is CT1, and a central thickness of the fourth lens element is CT4, the following condition can be satisfied: 0.30<CT4/CT1<1.00. Therefore, it is favorable for adjusting the central thickness ratio between the first and fourth lens elements, thereby reducing manufacturing tolerance. Moreover, the following condition can also be satisfied: 0.35<CT4/CT1<0.90.

When an axial distance between the fourth lens element and the fifth lens element is T45, and an axial distance between the fifth lens element and the sixth lens element is T56, the following condition can be satisfied: 0.05<T56/T45<1.00. Therefore, it is favorable for adjusting the space arrangement of the fifth lens element to improve light convergence effect at the central region. Moreover, the following condition can also be satisfied: 0.15<T56/T45<0.85.

When an f-number of the optical photography lens system is Fno, the following condition can be satisfied: 1.45<Fno<1.90. Therefore, it is favorable for increasing brightness of images while having a proper depth of view of the optical photography lens system. Moreover, the following condition can also be satisfied: 1.48<Fno<1.87. Moreover, the following condition can also be satisfied: 1.52≤Fno≤1.84.

When the total number of the plurality of lens elements is seven or eight, a lens thickness of the sixth lens element in parallel with the optical axis at the maximum effective radius position of the minimum opening of the light-blocking element is ST6, and a lens thickness of the seventh lens element in parallel with the optical axis at the maximum effective radius position of the minimum opening of the light-blocking element is ST7, the following condition can be satisfied: 1.80<ST7/ST6<3.60. Therefore, it is favorable for balancing the space arrangement of lens elements, thereby correcting convergence of light from the peripheral field of view and improving image quality. Moreover, the following condition can also be satisfied: 2.00<ST7/ST6<3.50. Please refer to FIG. 28, which shows a schematic view of ST6 and ST7 according to the 1st embodiment of the present disclosure. In some cases, ST6 can also be considered as a lens thickness of the sixth lens element in parallel with the optical axis at the maximum effective radius position of the object-side surface of the light-blocking element. In some cases, ST7 can also be considered as a lens thickness of the seventh lens element in parallel with the optical axis at the maximum effective radius position of the object-side surface of the light-blocking element.

When a displacement in parallel with the optical axis from an axial vertex on the image-side surface of the second lens element to a maximum effective radius position on the image-side surface of the second lens element is SAG2R2, and a displacement in parallel with the optical axis from an axial vertex on the object-side surface of the third lens element to a maximum effective radius position on the object-side surface of the third lens element is SAG3R1, the following condition can be satisfied: −1.70<SAG3R1/SAG2R2<−0.25. Therefore, it is favorable for adjusting the surface design at the lens peripheries of the second and third lens elements so as to facilitate light receiving and aberration correction. Moreover, the following condition can also be satisfied: −1.55<SAG3R1/SAG2R2<−0.30. Please refer to FIG. 28, which shows a schematic view of SAG2R2 and SAG3R1 according to the 1st embodiment of the present disclosure. When the direction from the axial vertex of one surface to the maximum effective radius position of the same surface is facing towards the image side of the photography optical lens assembly, the value of displacement is positive; when the direction from the axial vertex of the surface to the maximum effective radius position of the same surface is facing towards the object side of the photography optical lens assembly, the value of displacement is negative.

When a displacement in parallel with the optical axis from an axial vertex on the object-side surface of the fifth lens element to a maximum effective radius position on the object-side surface of the fifth lens element is SAG5R1, and a central thickness of the fifth lens element is CT5, the following condition can be satisfied: −1.80<SAG5R1/CT5<−0.50. Therefore, it is favorable for preventing excessive elongation at the peripheral lens surface of the object-side surface of the fifth lens element, thereby reducing light divergence and assisting in reduction in internal stress when shaping the lens element. Moreover, the following condition can also be satisfied: −1.70<SAG5R1/CT5<−0.60. Please refer to FIG. 28, which shows a schematic view of SAG5R1 according to the 1st embodiment of the present disclosure. When the direction from the axial vertex of one surface to the maximum effective radius position of the same surface is facing towards the image side of the photography optical lens assembly, the value of displacement is positive; when the direction from the axial vertex of the surface to the maximum effective radius position of the same surface is facing towards the object side of the photography optical lens assembly, the value of displacement is negative.

When a focal length of the first lens element is f1, and a composite focal length of the fourth lens element and the fifth lens element is f45, the following condition can be satisfied: −0.50<f1/f45<1.00. Therefore, it is favorable for adjusting the travelling direction of the optical path so as to obtain a proper balance between the controlling to the total track length and the image quality. Moreover, the following condition can also be satisfied: −0.30<f1/f45<0.80. Moreover, the following condition can also be satisfied: 0<f1/f45<0.70.

When an axial distance between the first lens element and the second lens element is T12, and the central thickness of the third lens element is CT3, the following condition can be satisfied: 0≤T12/CT3<1.00. Therefore, it is favorable for balancing the distance along the optical axis between the first lens element and the second lens element and the central thickness of the third lens element, thereby increasing productivity and space utilization. Moreover, the following condition can also be satisfied: 0.03<T12/CT3<0.70. Moreover, the following condition can also be satisfied: 0.05<T12/CT3<0.25.

When an axial distance between the third lens element and the fourth lens element is T34, and the central thickness of the second lens element is CT2, the following condition can be satisfied: 0≤T34/CT2<1.00. Therefore, it is favorable for balancing the distance along the optical axis between the third lens element and the fourth lens element and the central thickness of the second lens element, thereby facilitating lens assembly and improving yield rate. Moreover, the following condition can also be satisfied: 0.05<T34/CT2<0.75. Moreover, the following condition can also be satisfied: 0.10<T34/CT2<0.35.

When a displacement in parallel with the optical axis from the most-object-end of the light-blocking element to an axial vertex on the image-side surface of the first lens element is DsR2, and a displacement in parallel with the optical axis from the most-object-end of the lens barrel to the axial vertex on the image-side surface of the first lens element is DbR2, the following condition can be satisfied: 0.05<DsR2/DbR2<0.90. Therefore, it is favorable for adjusting the position of the light-blocking element so as to prevent stray light and glare of photographed images. Moreover, the following condition can also be satisfied: 0.10<DsR2/DbR2<0.80. Moreover, the following condition can also be satisfied: 0.20<DsR2/DbR2<0.70. Moreover, the following condition can also be satisfied: 0.27≤DsR2/DbR2≤0.57. Please refer to FIG. 28, which shows a schematic view of DbR2 and DsR2 according to the 1st embodiment of the present disclosure. When the direction of the said displacement is facing towards the image side of the optical photography lens system, the value of the said displacement is positive; when the direction of the said displacement is facing towards the object side of the optical photography lens system, the value of the said displacement is negative. In some cases, DsR2 can also be considered as a displacement in parallel with the optical axis from the object-side surface of the light-blocking element to the axial vertex on the image-side surface of the first lens element. In some cases, DbR2 can also be considered as a displacement in parallel with the optical axis from the lens-barrel-object-end outer surface to the axial vertex on the image-side surface of the first lens element.

When the total number of the plurality of lens elements is seven or eight, a curvature radius of the object-side surface of the seventh lens element is R13, and a curvature radius of the image-side surface of the seventh lens element is R14, the following condition can be satisfied: −1.00<R14/R13<0.10. Therefore, it is favorable for adjusting the lens surface and the refractive power of the seventh lens element, thereby correcting field curvature and astigmatism and improving convergence quality of imaging light. Moreover, the following condition can also be satisfied: −0.80<R14/R13<0. Moreover, the following condition can also be satisfied: −0.55<R14/R13<−0.10.

When a curvature radius of the object-side surface of the sixth lens element is R11, and a curvature radius of the image-side surface of the sixth lens element is R12, the following condition can be satisfied: −1.00<R11/R12<0.20. Therefore, it is favorable for arranging the lens surface at the central region of the object-side surface of the sixth lens element more curved than that of the image-side surface of the sixth lens element, thereby correcting aberrations and reducing the total track length. Moreover, the following condition can also be satisfied: −0.80<R11/R12<0.10. Moreover, the following condition can also be satisfied: −0.70<R11/R12<0.

When a focal length of the optical photography lens system is f, and the focal length of the first lens element is f1, the following condition can be satisfied: 0.40<f/f1<1.50. Therefore, it is favorable for having a certain degree of positive refractive power of the first lens element, thereby reducing the size at the object end of the optical photography lens system. Moreover, the following condition can also be satisfied: 0.50<f/f1<1.40.

When a maximum effective radius of the image-side surface of the second lens element is Y2R2, a maximum effective radius of the image-side surface of the third lens element is Y3R2, and a maximum effective radius of the image-side surface of the fourth lens element is Y4R2, the following condition can be satisfied: −0.10<(Y3R2−Y2R2)/(Y4R2−Y3R2)<1.20. Therefore, it is favorable for harmonizing the peripheral optical path while controlling the outer diameter size at the object end of the optical photography lens system. Moreover, the following condition can also be satisfied: 0.05<(Y3R2−Y2R2)/(Y4R2−Y3R2)<1.10. Please refer to FIG. 27, which shows a schematic view of Y2R2, Y3R2 and Y4R2 according to the 1st embodiment of the present disclosure.

When a displacement in parallel with the optical axis from an axial vertex on the image-side surface of the third lens element to a maximum effective radius position on the image-side surface of the third lens element is SAG3R2, and a displacement in parallel with the optical axis from an axial vertex on the image-side surface of the fourth lens element to a maximum effective radius position on the image-side surface of the fourth lens element is SAG4R2, the following condition can be satisfied: 0<SAG3R2/SAG4R2<0.60. Therefore, it is favorable for collaborating the third lens element and the fourth lens element to guide the deflection angle of peripheral light so as to reduce the difference in convergence position of light with different wavelengths. Moreover, the following condition can also be satisfied: 0.05<SAG3R2/SAG4R2<0.50. Please refer to FIG. 28, which shows a schematic view of SAG3R2 and SAG4R2 according to the 1st embodiment of the present disclosure. When the direction from the axial vertex of one surface to the maximum effective radius position of the same surface is facing towards the image side of the photography optical lens assembly, the value of displacement is positive; when the direction from the axial vertex of the surface to the maximum effective radius position of the same surface is facing towards the object side of the photography optical lens assembly, the value of displacement is negative.

When the maximum effective radius of the image-side surface of the fourth lens element is Y4R2, a maximum effective radius of the object-side surface of the fifth lens element is Y5R1, a maximum effective radius of the image-side surface of the fifth lens element is Y5R2, and a maximum effective radius of the object-side surface of the sixth lens element is Y6R1, the following condition can be satisfied: 0.30<(Y5R1−Y4R2)/(Y6R1−Y5R2)<1.30. Therefore, it is favorable for enlarging the image surface while preventing total reflection. Moreover, the following condition can also be satisfied: 0.50<(Y5R1−Y4R2)/(Y6R1−Y5R2)<1.10. Please refer to FIG. 27, which shows a schematic view of Y4R2, Y5R1, Y5R2 and Y6R1 according to the 1st embodiment of the present disclosure.

When a distance in parallel with the optical axis between a maximum effective radius position of the object-side surface of the first lens element and a maximum effective radius position of the image-side surface of the first lens element is ET1, and a distance in parallel with the optical axis between a maximum effective radius position of the object-side surface of the second lens element and a maximum effective radius position of the image-side surface of the second lens element is ET2, the following condition can be satisfied: 1.00<ET1/ET2<3.00. Therefore, it is favorable for reducing light scattering inside the optical photography lens system, thereby accurately reproducing the imaged object in images. Moreover, the following condition can also be satisfied: 1.30<ET1/ET2<2.90. Please refer to FIG. 27, which shows a schematic view of ET1 and ET2 according to the 1st embodiment of the present disclosure.

When the distance in parallel with the optical axis between the maximum effective radius position of the object-side surface of the first lens element and the maximum effective radius position of the image-side surface of the first lens element is ET1, and a distance in parallel with the optical axis between the maximum effective radius position of the object-side surface of the fifth lens element and a maximum effective radius position of the image-side surface of the fifth lens element is ET5, the following condition can be satisfied: 0.80<ET1/ET5<2.00. Therefore, it is favorable for balancing the travelling direction of peripheral light while maintaining the feasibility of machining lens elements. Moreover, the following condition can also be satisfied: 0.90<ET1/ET5<1.80. Please refer to FIG. 27, which shows a schematic view of ET1 and ET5 according to the 1st embodiment of the present disclosure.

When the maximum effective radius of the minimum opening of the light-blocking element is Ys0, and a maximum effective radius of the lens-barrel-minimum-opening of the lens barrel is Ybo, the following condition can be satisfied: 0.95<Ys0/Ybo<1.05. Therefore, it is favorable for adjusting the ratio in minimum opening between the light-blocking element and the lens barrel so as to reduce stray light. Please refer to FIG. 27, which shows a schematic view of Ys0 and Ybo according to the 1st embodiment of the present disclosure.

When the maximum effective radius of the minimum opening of the light-blocking element is Ys0, and a maximum image height of the optical photography lens system (which can be half of a diagonal length of an effective photosensitive area of the image sensor) is ImgH, the following condition can be satisfied: 0.10<Ys0/ImgH<0.50. Therefore, it is favorable for effectively reducing the outer diameter size at the object end of the optical photography lens system and also enlarging the image surface. Moreover, the following condition can also be satisfied: 0.15<Ys0/ImgH<0.45. Moreover, the following condition can also be satisfied: 0.20<Ys0/ImgH<0.40.

According to the present disclosure, the aforementioned features and conditions can be utilized in numerous combinations so as to achieve corresponding effects.

According to the present disclosure, the lens elements of the optical photography lens system can be made of either glass or plastic material. When the lens elements are made of glass material, the refractive power distribution of the optical photography lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical photography lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the optical photography lens system, based on the corresponding image sensor, can be flat or curved, especially a curved surface being concave facing towards the object side of the optical photography lens system.

According to the present disclosure, an image correction unit, such as a field flattener, can be optionally disposed between the lens element closest to the image side of the optical photography lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, the optical photography lens system can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical photography lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the optical photography lens system and thereby provides a wider field of view for the same.

According to the present disclosure, the optical photography lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical photography lens system can include one or more optical elements for limiting the form of light passing through the optical photography lens system. Each optical element can be, but not limited to, a filter, a polarizer, etc., and each optical element can be, but not limited to, a single-piece element, a composite component, a thin film, etc. The optical element can be located at the object side or the image side of the optical photography lens system or between any two adjacent lens elements so as to allow light in a specific form to pass through, thereby meeting application requirements.

According to the present disclosure, the optical photography lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a kind of light-blocking element, an annular spacer, a barrel element, a cover glass, a blue glass, a filter, a color filter, an optical path folding element, a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the optical photography lens system can further include an additional light-blocking element. The additional light-blocking element can have a non-circular opening, and the non-circular opening can have different effective radii in different directions which are perpendicular to the optical axis. Therefore, it is favorable for coordinating with the shape of non-circular lens elements or aperture stop so as to effectively save the space and make full use of the light passing through said non-circular lens elements or aperture stop, thereby reducing stray light. Moreover, the additional light-blocking element can be provided with a wavy structure or a jagged structure at a periphery of an inner hole portion thereof.

According to the present disclosure, the object side and the image side are defined in accordance with the direction of the optical axis, and the axial optical data are calculated along the optical axis. Furthermore, if the optical axis is folded by a light-folding element, the axial optical data are also calculated along the folded optical axis.

According to the above description of the present disclosure, the following specific embodiments are provided for further explanation.

### 1st Embodiment

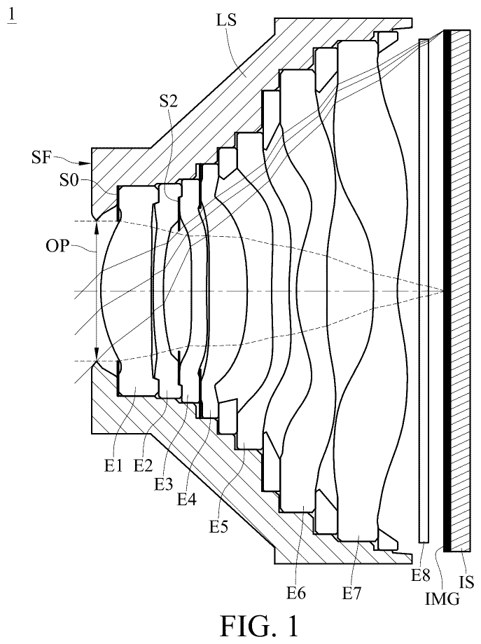

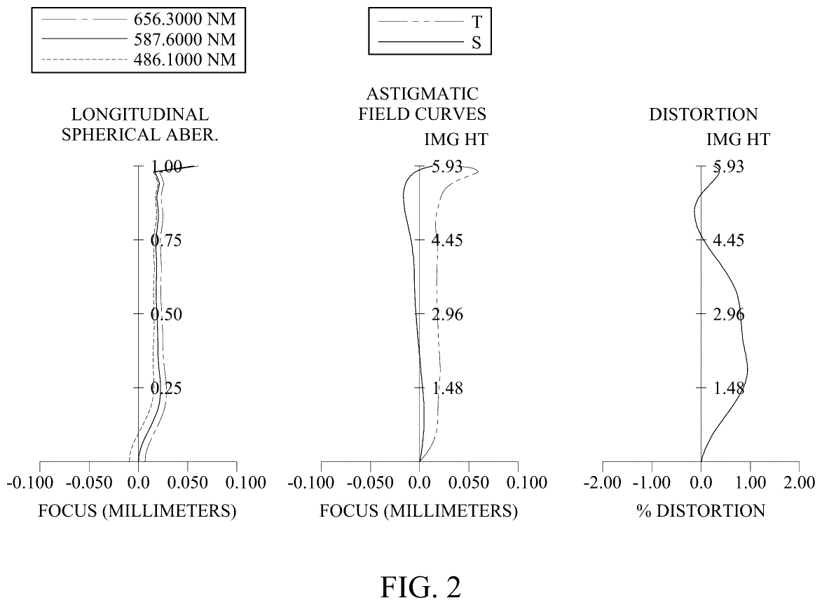

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the optical photography lens system (its reference numeral is omitted) of the present disclosure and an image sensor IS.

The optical photography lens system includes a lens barrel LS, seven lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The seven lens elements are disposed in the lens barrel LS. The seven lens elements are, in order from the object side to an image side along the optical axis, a first lens element E1, a second lens element E2, a third lens element E3, a fourth lens element E4, a fifth lens element E5, a sixth lens element E6 and a seventh lens element E7.

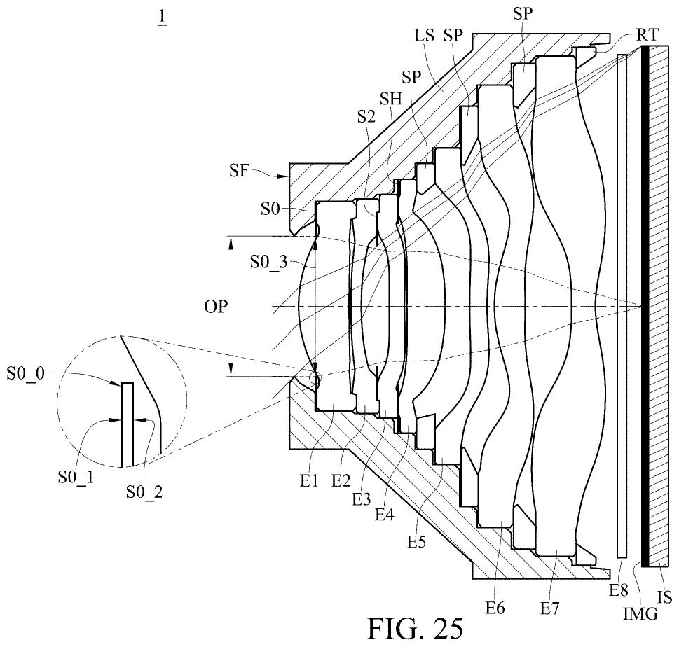

The light-blocking elements S0 and S2 are located in the lens barrel LS. Please together refer to FIG. 25, which is a schematic view showing configuration relationship between each element in the 1st embodiment of the present disclosure. As shown in FIG. 25, the light-blocking element S0 has an object-side surface S0_1 facing towards the object side, an image-side surface S0_2 facing towards the image side, a minimum opening S0_3 located between the object-side surface S0_1 and the image-side surface S0_2 of the light-blocking element S0, and a bore surface (not numbered) connected to and located between the object-side surface S0_1 and the image-side surface S0_2 of the light-blocking element S0. Moreover, the light-blocking element S0 further has a most-object-end S0_0 located on the object-side surface S0_1 and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, the fifth lens element E5, the sixth lens element E6, the seventh lens element E7, a filter E8 and an image surface IMG. The optical photography lens system includes seven lens elements (E1, E2, E3, E4, E5, E6 and E7) with no additional lens element disposed between each of the adjacent seven lens elements.

As shown in FIG. 25, the optical photography lens system further includes a light-blocking sheet SH, spacers SP and a retainer RT. The light-blocking sheet SH is disposed between adjacent two lens elements of the seven lens elements to provide a further light-blocking effect. Each spacer SP is disposed between adjacent two lens elements of the seven lens elements to secure the arrangement of the lens elements. The retainer RT is disposed on an image side of the seven lens elements to ensure that the seven lens elements are firmly disposed in the lens barrel LS. Please be noted that the optical photography lens system in other embodiments may also include one or more light-blocking sheets, one or more spacers or one or more retainers, but they are not numbered in the drawings for simplicity.

In this embodiment, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with negative refractive power has an object-side surface being convex in a paraxial region thereof and an image-side surface being concave in a paraxial region thereof. The third lens element E3 is made of glass material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has three inflection points. The object-side surface of the sixth lens element E6 has one critical point in an off-axis region thereof. The image-side surface of the sixth lens element E6 has two critical points in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has three inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the optical photography lens system. The image sensor IS is disposed on or near the image surface IMG of the optical photography lens system.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{j} ( Ai ) \times ( {Y}^{i} ) ,$$

where,
X is the displacement in parallel with the optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26, 28 and 30.

In the optical photography lens system of the image capturing unit 1 according to the 1st embodiment, when a focal length of the optical photography lens system is f, an f-number of the optical photography lens system is Fno, half of a maximum field of view of the optical photography lens system is HFOV, and the maximum field of view of the optical photography lens system is FOV, these parameters have the following values: f=5.84 millimeters (mm), Fno=1.84, HFOV=45.3 degrees (deg.), and FOV=90.6 degrees.

When the focal length of the optical photography lens system is f, and a focal length of the first lens element E1 is f1, the following condition is satisfied: f/f1=0.89.

When the focal length of the first lens element E1 is f1, and a composite focal length of the fourth lens element E4 and the fifth lens element E5 is f45, the following condition is satisfied: f1/f45=0.29.

When a curvature radius of the object-side surface of the sixth lens element E6 is R11, and a curvature radius of the image-side surface of the sixth lens element E6 is R12, the following condition is satisfied: R11/R12=−0.17.

When a curvature radius of the object-side surface of the seventh lens element E7 is R13, and a curvature radius of the image-side surface of the seventh lens element E7 is R14, the following condition is satisfied: R14/R13=−0.21.

When a displacement in parallel with the optical axis from the most-object-end SF of the lens barrel LS to an axial vertex on the object-side surface of the first lens element E1 is DbR1, the following condition is satisfied: DbR1=0.21 mm. In this embodiment, the direction of DbR1 is facing towards the image side of the optical photography lens system, so the value of DbR1 is positive.

When a displacement in parallel with the optical axis from the most-object-end S0_0 of the light-blocking element S0 to an axial vertex on the image-side surface of the first lens element E1 is DsR2, and a displacement in parallel with the optical axis from the most-object-end SF of the lens barrel LS to the axial vertex on the image-side surface of the first lens element E1 is DbR2, the following condition is satisfied: DsR2/DbR2=0.57. In this embodiment, the direction of DsR2 is facing towards the image side of the optical photography lens system, so the value of DsR2 is positive. In this embodiment, the direction of DbR2 is facing towards the image side of the optical photography lens system, so the value of DbR2 is positive.

When a central thickness of the first lens element E1 is CT1, and a lens thickness of the first lens element E1 in parallel with the optical axis at a maximum effective radius position of the minimum opening S0_3 of the light-blocking element S0 is ST1, the following condition is satisfied: CT1/ST1=1.56.

When the central thickness of the first lens element E1 is CT1, and a central thickness of the second lens element E2 is CT2, the following condition is satisfied: CT2/CT1=0.20.

When the central thickness of the first lens element E1 is CT1, and a central thickness of the third lens element E3 is CT3, the following condition is satisfied: CT3/CT1=0.30.

When the central thickness of the first lens element E1 is CT1, and a central thickness of the fourth lens element E4 is CT4, the following condition is satisfied: CT4/CT1=0.76.

When a maximum effective radius of the minimum opening S0_3 of the light-blocking element S0 is Ys0, and a maximum image height of the optical photography lens system is ImgH, the following condition is satisfied: Ys0/ImgH=0.27.

When an axial distance between the first lens element E1 and the second lens element E2 is T12, and the central thickness of the third lens element E3 is CT3, the following condition is satisfied: T12/CT3=0.13. In this embodiment, an axial distance between two adjacent lens elements is a distance in a paraxial region between two adjacent lens surfaces of the two adjacent lens elements.

When an axial distance between the second lens element E2 and the third lens element E3 is T23, and the central thickness of the second lens element E2 is CT2, the following condition is satisfied: T23/CT2=2.72.

When an axial distance between the third lens element E3 and the fourth lens element E4 is T34, and the central thickness of the second lens element E2 is CT2, the following condition is satisfied: T34/CT2=0.24.

When an axial distance between the fourth lens element E4 and the fifth lens element E5 is T45, and an axial distance between the fifth lens element E5 and the sixth lens element E6 is T56, the following condition is satisfied: T56/T45=0.30.

When an Abbe number of the first lens element E1 is V1, and an Abbe number of the second lens element E2 is V2, the following condition is satisfied: V1-V2=37.8.

When an Abbe number of the third lens element E3 is V3, and an Abbe number of the fourth lens element E4 is V4, the following condition is satisfied: V4-V3=38.1.

When a displacement in parallel with the optical axis from the most-object-end SF of the lens barrel LS to the most-object-end S0_0 of the light-blocking element S0 is Dbs0, and the maximum effective radius of the minimum opening S0_3 of the light-blocking element S0 is Ys0, the following condition is satisfied: Dbs0/Ys0=0.37. In this embodiment, the direction of Dbs0 is facing towards the image side of the optical photography lens system, so the value of Dbs0 is positive.

When a maximum effective radius of the image-side surface of the second lens element E2 is Y2R2, a maximum effective radius of the image-side surface of the third lens element E3 is Y3R2, and a maximum effective radius of the image-side surface of the fourth lens element E4 is Y4R2, the following condition is satisfied: (Y3R2−Y2R2)/(Y4R2−Y3R2)=0.95.

When the maximum effective radius of the image-side surface of the fourth lens element E4 is Y4R2, a maximum effective radius of the object-side surface of the fifth lens element E5 is Y5R1, a maximum effective radius of the image-side surface of the fifth lens element E5 is Y5R2, and a maximum effective radius of the object-side surface of the sixth lens element E6 is Y6R1, the following condition is satisfied: (Y5R1−Y4R2)/(Y6R1−Y5R2)=0.70.

When a distance in parallel with the optical axis between a maximum effective radius position of the object-side surface of the first lens element E1 and a maximum effective radius position of the image-side surface of the first lens element E1 is ET1, and a distance in parallel with the optical axis between a maximum effective radius position of the object-side surface of the second lens element E2 and a maximum effective radius position of the image-side surface of the second lens element E2 is ET2, the following condition is satisfied: ET1/ET2=2.36.

When the distance in parallel with the optical axis between the maximum effective radius position of the object-side surface of the first lens element E1 and the maximum effective radius position of the image-side surface of the first lens element E1 is ET1, and a distance in parallel with the optical axis between a maximum effective radius position of the object-side surface of the fifth lens element E5 and a maximum effective radius position of the image-side surface of the fifth lens element E5 is ET5, the following condition is satisfied: ET1/ET5=1.61.

When a lens thickness of the sixth lens element E6 in parallel with the optical axis at the maximum effective radius position of the minimum opening S0_3 of the light-blocking element S0 is ST6, and a lens thickness of the seventh lens element E7 in parallel with the optical axis at the maximum effective radius position of the minimum opening S0_3 of the light-blocking element S0 is ST7, the following condition is satisfied: ST7/ST6=2.13.

When a displacement in parallel with the optical axis from an axial vertex on the image-side surface of the second lens element E2 to the maximum effective radius position on the image-side surface of the second lens element E2 is SAG2R2, and a displacement in parallel with the optical axis from an axial vertex on the object-side surface of the third lens element E3 to a maximum effective radius position on the object-side surface of the third lens element E3 is SAG3R1, the following condition is satisfied: SAG3R1/SAG2R2=−0.97. In this embodiment, the direction of SAG2R2 is facing towards the image side of the optical photography lens system, so the value of SAG2R2 is positive. In this embodiment, the direction of SAG3R1 is facing towards the object side of the optical photography lens system, so the value of SAG3R1 is negative.

When a displacement in parallel with the optical axis from an axial vertex on the image-side surface of the third lens element E3 to a maximum effective radius position on the image-side surface of the third lens element E3 is SAG3R2, and a displacement in parallel with the optical axis from an axial vertex on the image-side surface of the fourth lens element E4 to a maximum effective radius position on the image-side surface of the fourth lens element E4 is SAG4R2, the following condition is satisfied: SAG3R2/SAG4R2=0.22. In this embodiment, the direction of SAG3R2 is facing towards the object side of the optical photography lens system, so the value of SAG3R2 is negative. In this embodiment, the direction of SAG4R2 is facing towards the object side of the optical photography lens system, so the value of SAG4R2 is negative.

When a displacement in parallel with the optical axis from an axial vertex on the object-side surface of the fifth lens element E5 to the maximum effective radius position on the object-side surface of the fifth lens element E5 is SAG5R1, and a central thickness of the fifth lens element E5 is CT5, the following condition is satisfied: SAG5R1/CT5=−1.52. In this embodiment, the direction of SAG5R1 is facing towards the object side of the optical photography lens system, so the value of SAG5R1 is negative.

When the maximum effective radius of the minimum opening S0_3 of the light-blocking element S0 is Ys0, and a maximum effective radius of the lens-barrel-minimum-opening OP of the lens barrel LS is Ybo, the following condition is satisfied: Ys0/Ybo=0.99.

The detailed optical data of the 1st embodiment are shown in Table 1A and the aspheric surface data are shown in Table 1B below.

TABLE 1A
1st Embodiment
f = 5.84 mm, Fno = 1.84, HFOV = 45.3 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.488 | | | | |
| 2 | Stop | Plano | | −0.392 | | | | |
| 3 | Lens 1 | 3.0635 | (ASP) | 1.147 | Plastic | 1.534 | 56.0 | 6.56 |
| 4 | | 21.1550 | (ASP) | 0.044 | | | | |
| 5 | Lens 2 | 12.8084 | (ASP) | 0.234 | Plastic | 1.680 | 18.2 | −21.60 |
| 6 | | 6.7912 | (ASP) | 0.368 | | | | |
| 7 | Stop | Plano | | 0.269 | | | | |
| 8 | Lens 3 | 47.6032 | (ASP) | 0.346 | Glass | 1.946 | 17.9 | −17.30 |
| 9 | | 12.1362 | (ASP) | 0.057 | | | | |
| 10 | Lens 4 | 33.6195 | (ASP) | 0.870 | Plastic | 1.544 | 56.0 | 11.77 |
| 11 | | −7.8414 | (ASP) | 0.555 | | | | |
| 12 | Lens 5 | 11.8114 | (ASP) | 0.398 | Plastic | 1.639 | 23.5 | −21.75 |
| 13 | | 6.2991 | (ASP) | 0.165 | | | | |
| 14 | Lens 6 | 3.3643 | (ASP) | 0.699 | Plastic | 1.587 | 28.3 | 4.95 |
| 15 | | −19.6359 | (ASP) | 1.058 | | | | |
| 16 | Lens 7 | −12.9858 | (ASP) | 0.542 | Plastic | 1.587 | 28.3 | −3.76 |
| 17 | | 2.7055 | (ASP) | 0.500 | | | | |

| | | | | | | | |
|---|---|---|---|---|---|---|---|
| 18 | Filter | Plano | 0.210 | Glass | 1.517 | 64.2 | — |
| 19 | | Plano | 0.350 | | | | |
| 20 | Image | Plano | — | | | | |

Note:
Reference wavelength is 587.6 nm (d-line).
An effective radius of the stop (the lens-barrel-minimum-opening OP, Surface 1) is 1.600 mm.
An effective radius of the stop (the light-blocking element S0, Surface 2) is 1.591 mm.
An effective radius of the stop (the light-blocking element S2, Surface 7) is 1.376 mm.

TABLE 1B
Aspheric Coefficients

| Surface # | 3 | 4 | 5 | 6 |
|---|---|---|---|---|
| k= | 0.000E+00 | 0.000E+00 | 0.000E+00 | 0.000E+00 |
| A4= | −2.59034801E−03 | −1.68578669E−02 | −1.34252323E−02 | 3.01582048E−03 |
| A6= | 5.63730535E−03 | −7.96179736E−03 | 1.95182857E−02 | −1.24750368E−02 |
| A8= | −7.33580134E−03 | 1.25304912E−01 | 9.15717792E−03 | 9.54360974E−02 |
| A10= | −1.60679472E−02 | −3.97042989E−01 | −5.64916509E−02 | −2.87549181E−01 |
| A12= | 7.68876769E−02 | 7.43162092E−01 | 8.67104913E−02 | 5.30326020E−01 |
| A14= | −1.39065304E−01 | −9.19868226E−01 | −6.77675618E−02 | −6.46152635E−01 |
| A16= | 1.46972430E−01 | 7.74325432E−01 | 1.67421905E−02 | 5.28205143E−01 |
| A18= | −9.90698889E−02 | −4.44995466E−01 | 1.72248518E−02 | −2.86497727E−01 |
| A20= | 4.32088293E−02 | 1.71752492E−01 | −1.84790267E−02 | 9.88672834E−02 |
| A22= | −1.18249593E−02 | −4.25538549E−02 | 7.89614344E−03 | −1.96419284E−02 |
| A24= | 1.84811699E−03 | 6.11136362E−03 | −1.66852447E−03 | 1.70975047E−03 |
| A26= | −1.25933654E−04 | −3.86615128E−04 | 1.43007877E−04 | — |
| Surface # | 8 | 9 | 10 | 11 |
| k= | 0.000E+00 | 0.000E+00 | 0.000E+00 | 0.000E+00 |
| A4= | −3.04509757E−02 | −3.58275675E−02 | −3.11568996E−02 | −2.12654559E−02 |
| A6= | 1.98034413E−02 | 3.99835398E−02 | 6.60715353E−02 | −6.24256666E−05 |
| A8= | −8.30037132E−02 | −1.07898110E−01 | −1.67103930E−01 | 1.23609795E−02 |
| A10= | 1.82498536E−01 | 1.79726588E−01 | 2.81582418E−01 | −3.23079199E−02 |
| A12= | −2.64978149E−01 | −2.04846346E−01 | −3.31589198E−01 | 4.51655493E−02 |
| A14= | 2.59405418E−01 | 1.62397374E−01 | 2.76048100E−01 | −4.16050095E−02 |
| A16= | −1.72482110E−01 | −8.95045541E−02 | −1.62509637E−01 | 2.70542586E−02 |
| A18= | 7.67232368E−02 | 3.39695294E−02 | 6.75151209E−02 | −1.27388526E−02 |
| A20= | −2.18411006E−02 | −8.67145522E−03 | −1.96160151E−02 | 4.36844946E−03 |
| A22= | 3.59391244E−03 | 1.41608701E−03 | 3.89243016E−03 | −1.08104624E−03 |
| A24= | −2.59300285E−04 | −1.32847967E−04 | −5.01724835E−04 | 1.87992945E−04 |
| A26= | — | 5.40083008E−06 | 3.77914498E−05 | −2.17759798E−05 |
| A28= | — | — | −1.26016374E−06 | 1.50656433E−06 |
| A30= | — | — | — | −4.70133649E−08 |
| Surface # | 12 | 13 | 14 | 15 |
| k= | 0.000E+00 | 0.000E+00 | −1.000E+00 | 0.000E+00 |
| A4= | −2.33423534E−02 | −2.88088252E−02 | 2.45058949E−02 | 5.81989508E−02 |
| A6= | 5.51407684E−03 | −3.09335397E−02 | −4.49690181E−02 | −1.59414106E−02 |
| A8= | 2.73509496E−03 | 3.63428378E−02 | 3.20308877E−02 | −5.20738803E−04 |
| A10= | −5.60950822E−03 | −2.07746436E−02 | −1.60694784E−02 | 1.75872635E−03 |
| A12= | 3.59950474E−03 | 6.66177957E−03 | 5.60562253E−03 | −6.77001943E−04 |
| A14= | −1.51947942E−03 | −9.54726874E−04 | −1.38577627E−03 | 1.51443063E−04 |
| A16= | 5.16098385E−04 | −1.22667038E−04 | 2.45662286E−04 | −2.27420118E−05 |
| A18= | −1.50220898E−04 | 9.18245222E−05 | −3.13547220E−05 | 2.39659556E−06 |
| A20= | 3.56687558E−05 | −2.17674526E−05 | 2.87595896E−06 | −1.79771992E−07 |
| A22= | −6.33020212E−06 | 3.01487629E−06 | −1.87608377E−07 | 9.55972794E−09 |
| A24= | 7.78451602E−07 | −2.64893742E−07 | 8.49072765E−09 | −3.52288973E−10 |
| A26= | −6.16208778E−08 | 1.45859320E−08 | −2.53459308E−10 | 8.55574111E−12 |
| A28= | 2.80259936E−09 | −4.61078637E−10 | 4.48949896E−12 | −1.23154953E−13 |
| A30= | −5.54382175E−11 | 6.40325779E−12 | −3.57526468E−14 | 7.95862608E−16 |

| Surface # | 16 | 17 |
|---|---|---|
| k= | 0.000E+00 | −1.000E+00 |
| A4= | −5.14437591E−02 | −7.12048506E−02 |
| A6= | 9.81225295E−03 | 2.12694248E−02 |
| A8= | −1.78100558E−03 | −5.73573382E−03 |
| A10= | 7.16384275E−04 | 1.26269452E−03 |
| A12= | −1.96872400E−04 | −2.10047927E−04 |
| A14= | 3.24128099E−05 | 2.56409764E−05 |
| A16= | −3.49038112E−06 | −2.28978314E−06 |
| A18= | 2.59755985E−07 | 1.49826675E−07 |
| A20= | −1.36935681E−08 | −7.15876457E−09 |
| A22= | 5.12585426E−10 | 2.46520973E−10 |
| A24= | −1.33681995E−11 | −5.94958689E−12 |
| A26= | 2.31476523E−13 | 9.53800567E−14 |
| A28= | −2.39558157E−15 | −9.11339790E−16 |
| A30= | 1.12254582E−17 | 3.92393618E−18 |

In Table 1A, the curvature radius, the thickness and the focal length are shown in millimeters (mm). Surface numbers 0-20 represent the surfaces sequentially arranged from the object side to the image side along the optical axis. In Table 11B, k represents the conic coefficient of the equation of the aspheric surface profiles. A4-A30 represent the aspheric coefficients ranging from the 4th order to the 30th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

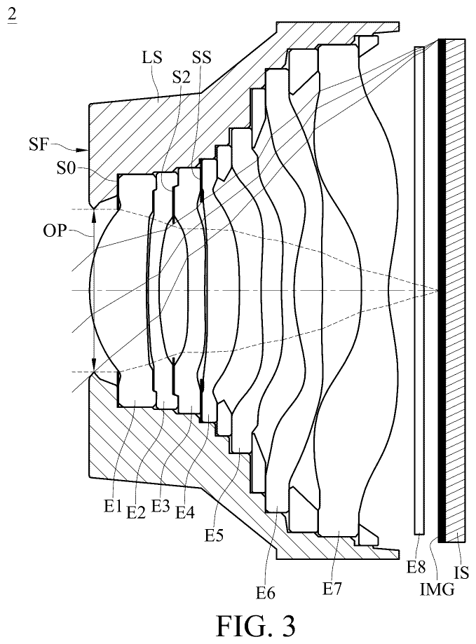

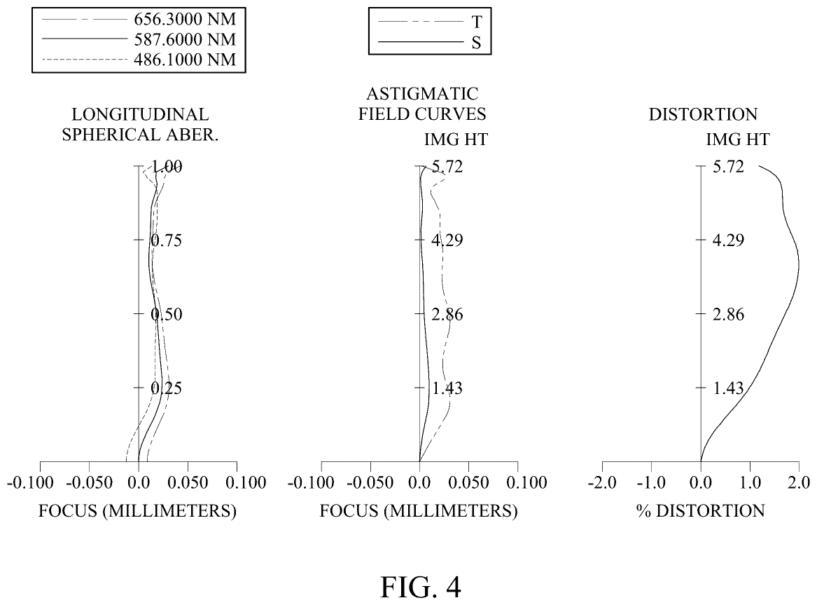

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the optical photography lens system (its reference numeral is omitted) of the present disclosure and an image sensor IS.

The optical photography lens system includes a lens barrel LS, seven lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The seven lens elements are disposed in the lens barrel LS. The seven lens elements are, in order from the object side to an image side along the optical axis, a first lens element E1, a second lens element E2, a third lens element E3, a fourth lens element E4, a fifth lens element E5, a sixth lens element E6 and a seventh lens element E7.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, a stop SS (light-blocking sheet), the fourth lens element E4, the fifth lens element E5, the sixth lens element E6, the seventh lens element E7, a filter E8 and an image surface IMG. The optical photography lens system includes seven lens elements (E1, E2, E3, E4, E5, E6 and E7) with no additional lens element disposed between each of the adjacent seven lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has two critical points in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has two critical points in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the optical photography lens system. The image sensor IS is disposed on or near the image surface IMG of the optical photography lens system.

The detailed optical data of the 2nd embodiment are shown in Table 2A and the aspheric surface data are shown in Table 2B3 below.

TABLE 2A
2nd Embodiment
f = 6.18 mm, Fno = 1.67, HFOV = 42.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.548 | | | | |
| 2 | Stop | Plano | | −0.648 | | | | |
| 3 | Lens 1 | 2.8991 | (ASP) | 1.295 | Plastic | 1.545 | 56.1 | 6.66 |
| 4 | | 12.1118 | (ASP) | 0.040 | | | | |
| 5 | Lens 2 | 10.6593 | (ASP) | 0.245 | Plastic | 1.669 | 19.5 | −23.56 |
| 6 | | 6.3004 | (ASP) | 0.328 | | | | |
| 7 | Stop | Plano | | 0.333 | | | | |
| 8 | Lens 3 | −284.6666 | (ASP) | 0.380 | Plastic | 1.669 | 19.5 | −18.11 |
| 9 | | 12.6628 | (ASP) | −0.067 | | | | |
| 10 | Stop | Plano | | 0.117 | | | | |
| 11 | Lens 4 | 21.0982 | (ASP) | 0.739 | Plastic | 1.544 | 56.0 | 15.54 |
| 12 | | −13.9310 | (ASP) | 0.492 | | | | |
| 13 | Lens 5 | 8.1366 | (ASP) | 0.463 | Plastic | 1.566 | 37.4 | −95.64 |
| 14 | | 6.9280 | (ASP) | 0.288 | | | | |
| 15 | Lens 6 | 4.1801 | (ASP) | 0.645 | Plastic | 1.544 | 56.0 | 5.45 |
| 16 | | −9.6454 | (ASP) | 0.887 | | | | |
| 17 | Lens 7 | −8.6445 | (ASP) | 0.613 | Plastic | 1.534 | 56.0 | −3.92 |
| 18 | | 2.8345 | (ASP) | 0.600 | | | | |

| | | | | | | | |
|---|---|---|---|---|---|---|---|
| 19 | Filter | Plano | 0.210 | Glass | 1.517 | 64.2 | — |
| 20 | | Plano | 0.333 | | | | |
| 21 | Image | Plano | — | | | | |

Note:
Reference wavelength is 587.6 nm (d-line).
An effective radius of the stop (the lens-barrel-minimum-opening OP, Surface 1) is 1.855 mm.
An effective radius of the stop (the light-blocking element S0, Surface 2) is 1.851 mm.
An effective radius of the stop (the light-blocking element S2, Surface 7) is 1.535 mm.
An effective radius of the stop SS (the light-blocking sheet, Surface 10) is 2.025 mm.

TABLE 2B
Aspheric Coefficients

| Surface # | 3 | 4 | 5 | 6 |
|---|---|---|---|---|
| k= | 0.000E+00 | 0.000E+00 | 0.000E+00 | 0.000E+00 |
| A4= | −2.73508538E−04 | −2.57028803E−02 | −3.00992351E−02 | −6.61257942E−03 |
| A6= | 2.23156082E−03 | 1.70461282E−02 | 2.57417925E−02 | 5.74945769E−03 |
| A8= | −6.68641552E−04 | −1.45646353E−02 | −3.22861894E−02 | 2.05137407E−03 |
| A10= | −5.72831385E−03 | 5.10080274E−02 | 9.12324426E−02 | −2.58687547E−03 |
| A12= | 1.32666775E−02 | −1.13736306E−01 | −1.81578835E−01 | −6.23317928E−03 |
| A14= | −1.50399609E−02 | 1.43124784E−01 | 2.22035779E−01 | 1.31754259E−02 |
| A16= | 1.04987318E−02 | −1.13198700E−01 | −1.76076403E−01 | −1.12122013E−02 |
| A18= | −4.79135083E−03 | 5.89021949E−02 | 9.31050255E−02 | 5.27627707E−03 |
| A20= | 1.43862076E−03 | −2.02390597E−02 | −3.26941973E−02 | −1.40371018E−03 |
| A22= | −2.74686201E−04 | 4.43708217E−03 | 7.33517105E−03 | 1.90574065E−04 |
| A24= | 3.03031546E−05 | −5.63813677E−04 | −9.52488314E−04 | −9.11376987E−06 |
| A26= | −1.47322410E−06 | 3.16353220E−05 | 5.44431545E−05 | — |
| Surface # | 8 | 9 | 11 | 12 |
| k= | 0.000E+00 | 0.000E+00 | 0.000E+00 | 0.000E+00 |
| A4= | −2.80224649E−02 | −3.31164616E−02 | −3.38748891E−02 | −2.91297157E−02 |
| A6= | 2.05619023E−02 | −1.62138008E−02 | 4.38892167E−03 | 2.72511711E−02 |
| A8= | −7.38706871E−02 | 9.91651742E−02 | 4.18246403E−02 | −7.60078485E−02 |
| A10= | 1.52115062E−01 | −1.98799341E−01 | −7.73132916E−02 | 1.47140869E−01 |
| A12= | −2.14488466E−01 | 2.27826481E−01 | 6.40472507E−02 | −1.91057058E−01 |
| A14= | 2.03673440E−01 | −1.71696339E−01 | −2.64075322E−02 | 1.70380912E−01 |
| A16= | −1.30135174E−01 | 8.98469562E−02 | 3.09788021E−03 | −1.07006896E−01 |
| A18= | 5.50706171E−02 | −3.30476684E−02 | 2.11142965E−03 | 4.80715484E−02 |
| A20= | −1.47862401E−02 | 8.38393938E−03 | −1.18795170E−03 | −1.55043878E−02 |
| A22= | 2.27955073E−03 | −1.39281497E−03 | 2.93097222E−04 | 3.55778410E−03 |
| A24= | −1.53299358E−04 | 1.35923796E−04 | −4.04801683E−05 | −5.66305972E−04 |
| A26= | — | −5.89146252E−06 | 3.03598234E−06 | 5.93718527E−05 |
| A28= | — | — | −9.65939277E−08 | −3.68321036E−06 |
| A30= | — | — | — | 1.02308910E−07 |
| Surface # | 13 | 14 | 15 | 16 |
| k= | 0.000E+00 | 0.000E+00 | −1.000E+00 | 0.000E+00 |
| A4= | −3.16707602E−02 | −3.49195675E−02 | 1.66924732E−02 | 4.69913823E−02 |
| A6= | 9.92556438E−03 | −2.42980025E−02 | −2.96292484E−02 | −1.07915781E−02 |
| A8= | −1.14721890E−02 | 2.97561695E−02 | 1.61726268E−02 | −4.62152857E−03 |
| A10= | 1.78766400E−02 | −1.65875386E−02 | −6.31855379E−03 | 4.53468631E−03 |
| A12= | −1.76659673E−02 | 5.54009305E−03 | 1.88569600E−03 | −1.77350307E−03 |
| A14= | 1.08082920E−02 | −1.14788750E−03 | −4.50342900E−04 | 4.18643214E−04 |
| A16= | −4.39754532E−03 | 1.25559314E−04 | 8.31762291E−05 | −6.57809260E−05 |
| A18= | 1.23746349E−03 | 2.66902611E−06 | −1.12933888E−05 | 7.17883897E−06 |
| A20= | −2.43881222E−04 | −3.35154340E−06 | 1.09449371E−06 | −5.53847324E−07 |
| A22= | 3.34365102E−05 | 5.67064300E−07 | −7.43139607E−08 | 3.01834745E−08 |
| A24= | −3.10780887E−06 | −5.12785341E−08 | 3.44754551E−09 | −1.13856901E−09 |
| A26= | 1.85627408E−07 | 2.70350273E−09 | −1.04106422E−10 | 2.83143957E−11 |
| A28= | −6.38323491E−09 | −7.78594651E−11 | 1.84528598E−12 | −4.17856070E−13 |
| A30= | 9.51979555E−11 | 9.39959398E−13 | −1.45773040E−14 | 2.77291501E−15 |

| Surface # | 17 | 18 |
|---|---|---|
| k= | 0.000E+00 | −1.000E+00 |
| A4= | −5.32582846E−02 | −6.99270643E−02 |
| A6= | 1.13305213E−02 | 2.12553142E−02 |
| A8= | −2.09364742E−03 | −5.61079805E−03 |
| A10= | 5.95957886E−04 | 1.17984258E−03 |
| A12= | −1.27516255E−04 | −1.86297467E−04 |
| A14= | 1.72355289E−05 | 2.14361309E−05 |
| A16= | −1.52983178E−06 | −1.77792035E−06 |
| A18= | 9.21226197E−08 | 1.05602391E−07 |
| A20= | −3.78463513E−09 | −4.44346119E−09 |
| A22= | 1.03338168E−10 | 1.29652805E−10 |
| A24= | −1.73052164E−12 | −2.52004017E−12 |
| A26= | 1.38006400E−14 | 3.02347557E−14 |
| A28= | 1.87283079E−17 | −1.90829636E−16 |
| A30= | −8.14084433E−19 | 4.06088211E−19 |

In the 2nd embodiment, the equation of the aspheric surface profiles of the aforementioned lens elements is the same as the equation of the 1st embodiment. Also, the definitions of these parameters shown in Table 2C are the same as those stated in the 1 st embodiment with corresponding values for the 2nd embodiment, so an explanation in this regard will not be provided again.

Moreover, these parameters can be calculated from Table 2A and Table 2B3 as the following values and satisfy the following conditions:

TABLE 2C
Schematic Parameters

| | | | |
|---|---|---|---|
| f [mm] | 6.18 | T23/CT2 | 2.70 |
| Fno | 1.67 | T34/CT2 | 0.20 |
| HFOV [deg.] | 42.4 | T56/T45 | 0.59 |
| FOV [deg.] | 84.8 | V1-V2 | 36.6 |
| f/f1 | 0.93 | V4-V3 | 36.5 |
| f1/f45 | 0.37 | Dbs0/Ys0 | 0.35 |
| R11/R12 | −0.43 | (Y3R2-Y2R2)/(Y4R2-Y3R2) | 0.97 |
| R14/R13 | −0.33 | (Y5R1-Y4R2)/(Y6R1-Y5R2) | 0.73 |
| DbR1 [mm] | 0.01 | ET1/ET2 | 2.00 |
| DsR2/DbR2 | 0.50 | ET1/ET5 | 1.40 |
| CT1/ST1 | 1.70 | ST7/ST6 | 3.34 |
| CT2/CT1 | 0.19 | SAG3R1/SAG2R2 | −1.12 |
| CT3/CT1 | 0.29 | SAG3R2/SAG4R2 | 0.29 |
| CT4/CT1 | 0.57 | SAG5R1/CT5 | −1.21 |
| Ys0/ImgH | 0.32 | Ys0/Ybo | 1.00 |
| T12/CT3 | 0.11 | — | — |

### 3rd Embodiment

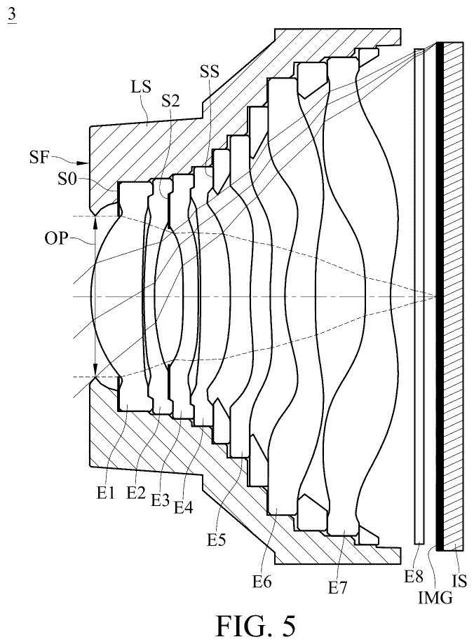

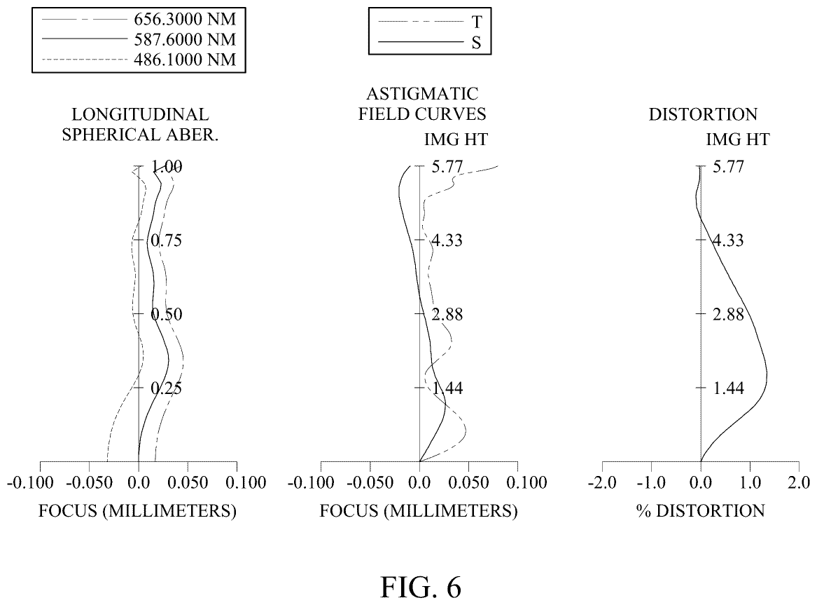

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the optical photography lens system (its reference numeral is omitted) of the present disclosure and an image sensor IS.

The optical photography lens system includes a lens barrel LS, seven lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The seven lens elements are disposed in the lens barrel LS. The seven lens elements are, in order from the object side to an image side along the optical axis, a first lens element E1, a second lens element E2, a third lens element E3, a fourth lens element E4, a fifth lens element E5, a sixth lens element E6 and a seventh lens element E7.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, a stop SS (spacer), the fifth lens element E5, the sixth lens element E6, the seventh lens element E7, a filter E8 and an image surface IMG. The optical photography lens system includes seven lens elements (E1, E2, E3, E4, E5, E6 and E7) with no additional lens element disposed between each of the adjacent seven lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the optical photography lens system. The image sensor IS is disposed on or near the image surface IMG of the optical photography lens system.

The detailed optical data of the 3rd embodiment are shown in Table 3A and the aspheric surface data are shown in Table 3B below.

TABLE 3A
3rd Embodiment
f = 6.18 mm, Fno = 1.69, HFOV = 43.0 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.529 | | | | |
| 2 | Stop | Plano | | −0.629 | | | | |
| 3 | Lens 1 | 2.8697 | (ASP) | 1.168 | Glass | 1.548 | 45.8 | 6.26 |
| 4 | | 15.0284 | (ASP) | 0.037 | | | | |
| 5 | Lens 2 | 9.7935 | (ASP) | 0.238 | Plastic | 1.669 | 19.5 | −17.62 |
| 6 | | 5.2972 | (ASP) | 0.333 | | | | |
| 7 | Stop | Plano | | 0.322 | | | | |
| 8 | Lens 3 | −18.2541 | (ASP) | 0.343 | Plastic | 1.686 | 18.4 | −28.66 |
| 9 | | −256.4103 | (ASP) | 0.050 | | | | |
| 10 | Lens 4 | −109.8901 | (ASP) | 0.679 | Plastic | 1.544 | 56.0 | 24.49 |
| 11 | | −11.9088 | (ASP) | −0.284 | | | | |
| 12 | Stop | Plano | | 0.735 | | | | |
| 13 | Lens 5 | 6.2538 | (ASP) | 0.454 | Plastic | 1.544 | 56.0 | 269.25 |
| 14 | | 6.3656 | (ASP) | 0.336 | | | | |
| 15 | Lens 6 | 3.8474 | (ASP) | 0.693 | Plastic | 1.562 | 44.6 | 7.09 |
| 16 | | 105.4950 | (ASP) | 1.138 | | | | |
| 17 | Lens 7 | −11.2453 | (ASP) | 0.569 | Plastic | 1.511 | 56.8 | −4.66 |
| 18 | | 3.0725 | (ASP) | 0.550 | | | | |

| | | | | | | | |
|---|---|---|---|---|---|---|---|
| 19 | Filter | Plano | 0.210 | Glass | 1.517 | 64.2 | — |
| 20 | | Plano | 0.292 | | | | |
| 21 | Image | Plano | — | | | | |

Note:
Reference wavelength is 587.6 nm (d-line).
An effective radius of the stop (the lens-barrel-minimum-opening OP, Surface 1) is 1.838 mm.
An effective radius of the stop (the light-blocking element S0, Surface 2) is 1.832 mm.
An effective radius of the stop (the light-blocking element S2, Surface 7) is 1.553 mm.
An effective radius of the stop SS (the spacer, Surface 12) is 2.312 mm.

TABLE 3B
Aspheric Coefficients

| Surface # | 3 | 4 | 5 | 6 |
|---|---|---|---|---|
| k= | 0.000E+00 | 0.000E+00 | 0.000E+00 | 0.000E+00 |
| A4= | −3.15019940E−03 | −3.38587905E−02 | −4.11004531E−02 | −1.51455467E−02 |
| A6= | 1.61791704E−02 | 5.08887715E−02 | 6.13467918E−02 | 4.37120169E−02 |
| A8= | −3.93157461E−02 | −8.88874670E−02 | −1.10659302E−01 | −1.21539643E−01 |
| A10= | 6.41122745E−02 | 1.82404927E−01 | 2.43210186E−01 | 2.67408938E−01 |
| A12= | −7.07045654E−02 | −2.74350009E−01 | −3.90360018E−01 | −3.89513414E−01 |
| A14= | 5.34582147E−02 | 2.69950146E−01 | 4.09780499E−01 | 3.70705423E−01 |
| A16= | −2.78512687E−02 | −1.76604774E−01 | −2.86276778E−01 | −2.32372177E−01 |
| A18= | 9.93298596E−03 | 7.80752601E−02 | 1.35144057E−01 | 9.51215968E−02 |
| A20= | −2.36857521E−03 | −2.31909277E−02 | −4.27734178E−02 | −2.44326921E−02 |
| A22= | 3.58471734E−04 | 4.45608014E−03 | 8.71754581E−03 | 3.56428357E−03 |
| A24= | −3.08178365E−05 | −5.02363227E−04 | −1.03519967E−03 | −2.24167654E−04 |
| A26= | 1.12744647E−06 | 2.52954374E−05 | 5.44224388E−05 | — |
| Surface # | 8 | 9 | 10 | 11 |
| k= | 0.000E+00 | 0.000E+00 | 0.000E+00 | 0.000E+00 |
| A4= | −8.69639928E−03 | −4.07058727E−02 | −4.24707452E−02 | −1.54965304E−02 |
| A6= | −1.02889240E−01 | 4.84050561E−02 | 1.02633884E−01 | −3.73572564E−02 |
| A8= | 3.14836843E−01 | −6.24937419E−02 | −1.58768741E−01 | 1.29620848E−01 |
| A10= | −6.26865416E−01 | 3.33689047E−02 | 1.50023426E−01 | −2.28826165E−01 |
| A12= | 8.23499896E−01 | 5.09509475E−04 | −9.95027731E−02 | 2.53689022E−01 |
| A14= | −7.33575407E−01 | −6.38665297E−03 | 5.48416465E−02 | −1.92297946E−01 |
| A16= | 4.45720677E−01 | −9.56159708E−04 | −2.73307282E−02 | 1.03725378E−01 |
| A18= | −1.82077365E−01 | 3.57246350E−03 | 1.14502989E−02 | −4.05439706E−02 |
| A20= | 4.78563204E−02 | −1.93918355E−03 | −3.58904521E−03 | 1.15412915E−02 |
| A22= | −7.31226215E−03 | 5.09753100E−04 | 7.74948917E−04 | −2.37706726E−03 |
| A24= | 4.93924785E−04 | −6.86930441E−05 | −1.07392328E−04 | 3.46807136E−04 |
| A26= | — | 3.81072627E−06 | 8.55522469E−06 | −3.42243807E−05 |
| A28= | — | — | −2.97113517E−07 | 2.06527111E−06 |
| A30= | — | — | — | −5.79859222E−08 |
| Surface # | 13 | 14 | 15 | 16 |
| k= | 0.000E+00 | 0.000E+00 | −1.000E+00 | 0.000E+00 |
| A4= | −4.37138399E−02 | −3.17962162E−02 | 2.39990846E−02 | 4.77764474E−02 |
| A6= | 3.38204519E−02 | −2.39195603E−02 | −3.68527281E−02 | −1.85371097E−02 |
| A8= | −4.51200649E−02 | 3.24890661E−02 | 2.06361262E−02 | −1.84789255E−04 |
| A10= | 5.67670591E−02 | −2.15769437E−02 | −8.71824282E−03 | 3.00389132E−03 |
| A12= | −5.27645212E−02 | 9.49371257E−03 | 2.88875282E−03 | −1.40148702E−03 |
| A14= | 3.39480872E−02 | −3.11505697E−03 | −7.44736405E−04 | 3.56561254E−04 |
| A16= | −1.53347958E−02 | 8.11513096E−04 | 1.42899148E−04 | −5.90722678E−05 |
| A18= | 4.94649869E−03 | −1.71113712E−04 | −1.97503320E−05 | 6.76120321E−06 |
| A20= | −1.14613122E−03 | 2.87217413E−05 | 1.93656273E−06 | −5.46409597E−07 |
| A22= | 1.89325958E−04 | −3.67843261E−06 | −1.33040175E−07 | 3.11792849E−08 |
| A24= | −2.17540294E−05 | 3.39390720E−07 | 6.25649100E−09 | −1.23084681E−09 |
| A26= | 1.65119765E−06 | −2.09431904E−08 | −1.91885553E−10 | 3.20107811E−11 |
| A28= | −7.43579302E−08 | 7.66782420E−10 | 3.45892790E−12 | −4.93635919E−13 |
| A30= | 1.50249603E−09 | −1.25334507E−11 | −2.78009665E−14 | 3.42016003E−15 |

| Surface # | 17 | 18 |
|---|---|---|
| k= | 0.000E+00 | −1.000E+00 |
| A4= | −5.28106802E−02 | −6.18606838E−02 |
| A6= | 1.10185928E−02 | 1.61761150E−02 |
| A8= | −3.16268413E−03 | −4.20391773E−03 |
| A10= | 1.34374818E−03 | 9.44794053E−04 |
| A12= | −3.48497715E−04 | −1.59483482E−04 |
| A14= | 5.52480015E−05 | 1.91206296E−05 |
| A16= | −5.80064522E−06 | −1.61162886E−06 |
| A18= | 4.22576840E−07 | 9.53199078E−08 |
| A20= | −2.17932294E−08 | −3.91946536E−09 |
| A22= | 7.95537449E−10 | 1.09211349E−10 |
| A24= | −2.01393678E−11 | −1.94996705E−12 |
| A26= | 3.36656455E−13 | 1.96598603E−14 |
| A28= | −3.34391189E−15 | −7.44903308E−17 |
| A30= | 1.49501081E−17 | −1.67198618E−19 |

In the 3rd embodiment, the equation of the aspheric surface profiles of the aforementioned lens elements is the same as the equation of the 1st embodiment. Also, the definitions of these parameters shown in Table 3C are the same as those stated in the 1 st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Schematic Parameters

| | | | |
|---|---|---|---|
| f [mm] | 6.18 | T23/CT2 | 2.75 |
| Fno | 1.69 | T34/CT2 | 0.21 |
| HFOV [deg.] | 43.0 | T56/T45 | 0.75 |
| FOV [deg.] | 86.0 | V1-V2 | 26.3 |
| f/f1 | 0.99 | V4-V3 | 37.6 |
| f1/f45 | 0.28 | Dbs0/Ys0 | 0.35 |
| R11/R12 | 0.04 | (Y3R2-Y2R2)/(Y4R2-Y3R2) | 0.76 |
| R14/R13 | −0.27 | (Y5R1-Y4R2)/(Y6R1-Y5R2) | 0.60 |
| DbR1 [mm] | 0.03 | ET1/ET2 | 1.54 |
| DsR2/DbR2 | 0.46 | ET1/ET5 | 1.22 |
| CT1/ST1 | 2.05 | ST7/ST6 | 2.19 |
| CT2/CT1 | 0.20 | SAG3R1/SAG2R2 | −1.16 |
| CT3/CT1 | 0.29 | SAG3R2/SAG4R2 | 0.43 |
| CT4/CT1 | 0.58 | SAG5R1/CT5 | −1.00 |
| Ys0/ImgH | 0.32 | Ys0/Ybo | 1.00 |
| T12/CT3 | 0.11 | — | — |

### 4th Embodiment

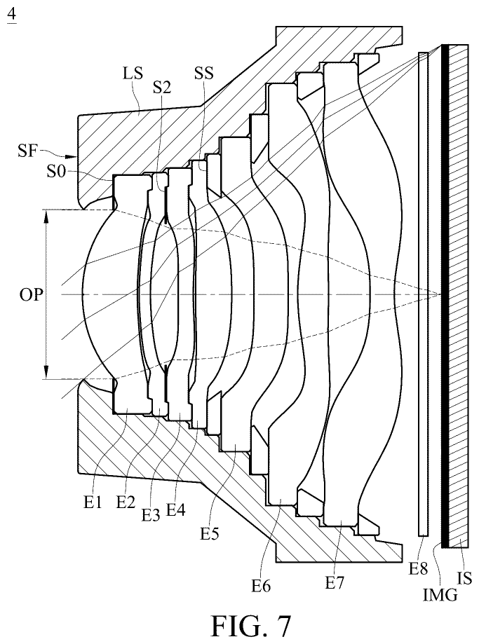

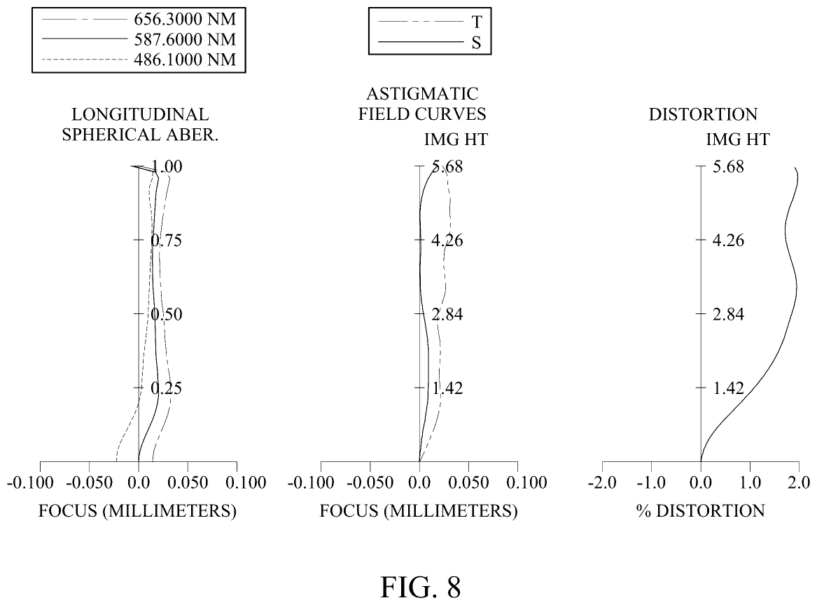

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the optical photography lens system (its reference numeral is omitted) of the present disclosure and an image sensor IS.

The optical photography lens system includes a lens barrel LS, seven lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The seven lens elements are disposed in the lens barrel LS. The seven lens elements are, in order from the object side to an image side along the optical axis, a first lens element E1, a second lens element E2, a third lens element E3, a fourth lens element E4, a fifth lens element E5, a sixth lens element E6 and a seventh lens element E7.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, a stop SS (spacer), the fifth lens element E5, the sixth lens element E6, the seventh lens element E7, a filter E8 and an image surface IMG. The optical photography lens system includes seven lens elements (E1, E2, E3, E4, E5, E6 and E7) with no additional lens element disposed between each of the adjacent seven lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has two inflection points. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has three inflection points. The object-side surface of the sixth lens element E6 has one critical point in an off-axis region thereof. The image-side surface of the sixth lens element E6 has two critical points in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the optical photography lens system. The image sensor IS is disposed on or near the image surface IMG of the optical photography lens system.

The detailed optical data of the 4th embodiment are shown in Table 4A and the aspheric surface data are shown in Table 4B below.

TABLE 4A
4th Embodiment
f = 6.35 mm, Fno = 1.65, HFOV = 41.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.679 | | | | |
| 2 | Stop | Plano | | −0.708 | | | | |
| 3 | Lens 1 | 2.9254 | (ASP) | 1.250 | Plastic | 1.534 | 56.0 | 8.74 |
| 4 | | 6.6634 | (ASP) | 0.040 | | | | |
| 5 | Lens 2 | 6.1048 | (ASP) | 0.258 | Plastic | 1.639 | 23.5 | 125.09 |
| 6 | | 6.5011 | (ASP) | 0.359 | | | | |
| 7 | Stop | Plano | | 0.273 | | | | |
| 8 | Lens 3 | 42.6989 | (ASP) | 0.342 | Plastic | 1.705 | 14.0 | −16.34 |
| 9 | | 9.0415 | (ASP) | 0.050 | | | | |
| 10 | Lens 4 | 15.6203 | (ASP) | 0.823 | Plastic | 1.544 | 56.0 | 11.55 |
| 11 | | −10.3228 | (ASP) | −0.240 | | | | |
| 12 | Stop | Plano | | 0.748 | | | | |
| 13 | Lens 5 | −60.1643 | (ASP) | 0.773 | Plastic | 1.669 | 19.5 | −33.35 |
| 14 | | 35.6406 | (ASP) | 0.220 | | | | |
| 15 | Lens 6 | 4.7265 | (ASP) | 0.700 | Plastic | 1.615 | 25.3 | 6.04 |
| 16 | | −16.4139 | (ASP) | 0.946 | | | | |
| 17 | Lens 7 | −9.3236 | (ASP) | 0.550 | Plastic | 1.614 | 25.6 | −3.82 |
| 18 | | 3.2020 | (ASP) | 0.555 | | | | |

| | | | | | | | |
|---|---|---|---|---|---|---|---|
| 19 | Filter | Plano | 0.210 | Glass | 1.517 | 64.2 | — |
| 20 | | Plano | 0.314 | | | | |
| 21 | Image | Plano | — | | | | |

Note:
Reference wavelength is 587.6 nm (d-line).
An effective radius of the stop (the lens-barrel-minimum-opening OP, Surface 1) is 1.931 mm.
An effective radius of the stop (the light-blocking element S0, Surface 2) is 1.924 mm.
An effective radius of the stop (the light-blocking element S2, Surface 7) is 1.615 mm.
An effective radius of the stop SS (the spacer, Surface 12) is 2.198 mm.

TABLE 4B
Aspheric Coefficients

| Surface # | 3 | 4 | 5 | 6 |
|---|---|---|---|---|
| k= | 0.000E+00 | 0.000E+00 | 0.000E+00 | 0.000E+00 |
| A4= | 1.40763272E−04 | −2.97928827E−02 | −3.36810320E−02 | −6.02891329E−03 |
| A6= | 1.35102312E−03 | 2.99675362E−03 | 1.11106130E−02 | −7.40924561E−03 |
| A8= | −2.26083800E−03 | 3.05822932E−02 | 4.20191660E−03 | 3.50498461E−02 |
| A10= | 2.45212358E−03 | −5.14856950E−02 | 1.05728444E−02 | −6.52138027E−02 |
| A12= | −1.42563155E−03 | 4.94998757E−02 | −4.23150510E−02 | 7.94241648E−02 |
| A14= | 2.81844310E−04 | −2.97812928E−02 | 6.07368536E−02 | −6.63690678E−02 |
| A16= | 1.72521616E−04 | 1.02751038E−02 | −5.08640303E−02 | 3.81157298E−02 |
| A18= | −1.44013126E−04 | −1.10553796E−03 | 2.73279065E−02 | −1.47581179E−02 |
| A20= | 4.73829136E−05 | −5.86219709E−04 | −9.53093374E−03 | 3.68551962E−03 |
| A22= | −8.24077922E−06 | 2.71130146E−04 | 2.08654161E−03 | −5.36923242E−04 |
| A24= | 7.25652343E−07 | −4.65266880E−05 | −2.60558715E−04 | 3.47885072E−05 |
| A26= | −2.43027538E−08 | 3.05510112E−06 | 1.41533838E−05 | — |
| Surface # | 8 | 9 | 10 | 11 |
| k= | 0.000E+00 | 0.000E+00 | 0.000E+00 | 0.000E+00 |
| A4= | −2.91342168E−02 | −3.00291698E−02 | −1.83132781E−02 | −1.88012387E−02 |
| A6= | 6.54068606E−03 | −1.31161773E−03 | 5.99349398E−03 | −9.45095984E−03 |
| A8= | −2.83605602E−02 | 1.09333309E−02 | −3.80848332E−05 | 5.07796402E−02 |
| A10= | 5.48876274E−02 | −3.21327113E−02 | −1.84400002E−02 | −1.15001279E−01 |
| A12= | −6.82159027E−02 | 5.20996592E−02 | 4.08829126E−02 | 1.61377514E−01 |
| A14= | 5.51740476E−02 | −5.27223294E−02 | −4.66843885E−02 | −1.53815264E−01 |
| A16= | −2.95211253E−02 | 3.51074194E−02 | 3.35792233E−02 | 1.03697765E−01 |
| A18= | 1.03534397E−02 | −1.56609689E−02 | −1.61896774E−02 | −5.03375844E−02 |
| A20= | −2.27657284E−03 | 4.64241392E−03 | 5.31555179E−03 | 1.76564833E−02 |
| A22= | 2.82556098E−04 | −8.78313384E−04 | −1.17338944E−03 | −4.43292284E−03 |
| A24= | −1.48755796E−05 | 9.60505541E−05 | 1.66510538E−04 | 7.76304423E−04 |
| A26= | — | −4.62155420E−06 | −1.36998271E−05 | −8.99980418E−05 |
| A28= | — | — | 4.95649216E−07 | 6.20249521E−06 |
| A30= | — | — | — | −1.92214064E−07 |
| Surface # | 13 | 14 | 15 | 16 |
| k= | 0.000E+00 | 0.000E+00 | −1.000E+00 | 0.000E+00 |
| A4= | −3.17477082E−02 | −6.49665745E−02 | −3.06520698E−02 | 2.70278613E−02 |
| A6= | 2.17809370E−02 | 4.66346965E−02 | 2.67602398E−02 | −1.46700750E−03 |
| A8= | −2.17407527E−02 | −4.38796554E−02 | −2.49448850E−02 | −5.53006174E−03 |
| A10= | 1.41795662E−02 | 3.31105905E−02 | 1.47983823E−02 | 3.25061916E−03 |
| A12= | −5.25155468E−03 | −1.87988937E−02 | −6.05169563E−03 | −1.00992945E−03 |
| A14= | −9.14251385E−05 | 7.99187703E−03 | 1.75349343E−03 | 2.02456024E−04 |
| A16= | 1.29275261E−03 | −2.56119701E−03 | −3.65280962E−04 | −2.79395567E−05 |
| A18= | −7.73059201E−04 | 6.20930809E−04 | 5.48303405E−05 | 2.73237178E−06 |
| A20= | 2.55031573E−04 | −1.13227170E−04 | −5.89431637E−06 | −1.91195966E−07 |
| A22= | −5.37785474E−05 | 1.52513317E−05 | 4.47573520E−07 | 9.50913902E−09 |
| A24= | 7.41372865E−06 | −1.46585489E−06 | −2.33801590E−08 | −3.27647415E−10 |
| A26= | −6.47685687E−07 | 9.46268592E−08 | 7.98621849E−10 | 7.40593057E−12 |
| A28= | 3.25651339E−08 | −3.65910665E−09 | −1.60572436E−11 | −9.80742402E−14 |
| A30= | −7.17719830E−10 | 6.37945520E−11 | 1.44136009E−13 | 5.69549401E−16 |

| Surface # | 17 | 18 |
|---|---|---|
| k= | 0.000E+00 | −1.000E+00 |
| A4= | −5.03521701E−02 | −6.33204402E−02 |
| A6= | 1.37475223E−02 | 1.88083976E−02 |
| A8= | −4.10506331E−03 | −5.01323064E−03 |
| A10= | 1.25413470E−03 | 1.05898833E−03 |
| A12= | −2.57399557E−04 | −1.66732475E−04 |
| A14= | 3.44079628E−05 | 1.92251351E−05 |
| A16= | −3.11262355E−06 | −1.62744574E−06 |
| A18= | 1.95184876E−07 | 1.01598737E−07 |
| A20= | −8.50010897E−09 | −4.66968674E−09 |
| A22= | 2.50940447E−10 | 1.56140732E−10 |
| A24= | −4.69961235E−12 | −3.69646932E−12 |
| A26= | 4.67799446E−14 | 5.87617943E−14 |
| A28= | −8.93992843E−17 | −5.63043387E−16 |
| A30= | −1.64350039E−18 | 2.45908734E−18 |

In the 4th embodiment, the equation of the aspheric surface profiles of the aforementioned lens elements is the same as the equation of the 1st embodiment. Also, the definitions of these parameters shown in Table 4C are the same as those stated in the 1 st embodiment with corresponding values for the 4th embodiment, so an explanation in this regard will not be provided again.

Moreover, these parameters can be calculated from Table 4A and Table 4B as the following values and satisfy the following conditions:

TABLE 4C
Schematic Parameters

| | | | |
|---|---|---|---|
| f [mm] | 6.35 | T23/CT2 | 2.45 |
| Fno | 1.65 | T34/CT2 | 0.19 |
| HFOV [deg.] | 41.2 | T56/T45 | 0.43 |
| FOV [deg.] | 82.4 | V1-V2 | 32.5 |
| f/f1 | 0.73 | V4-V3 | 42.0 |
| f1/f45 | 0.52 | Dbs0/Ys0 | 0.41 |
| R11/R12 | −0.29 | (Y3R2-Y2R2)/(Y4R2-Y3R2) | 0.86 |
| R14/R13 | −0.34 | (Y5R1-Y4R2)/(Y6R1-Y5R2) | 0.38 |
| DbR1 [mm] | 0.10 | ET1/ET2 | 2.73 |
| DsR2/DbR2 | 0.41 | ET1/ET5 | 1.16 |
| CT1/ST1 | 1.74 | ST7/ST6 | 2.15 |
| CT2/CT1 | 0.21 | SAG3R1/SAG2R2 | −0.92 |
| CT3/CT1 | 0.27 | SAG3R2/SAG4R2 | 0.21 |
| CT4/CT1 | 0.66 | SAG5R1/CT5 | −0.83 |
| Ys0/ImgH | 0.34 | Ys0/Ybo | 1.00 |
| T12/CT3 | 0.12 | — | — |

### 5th Embodiment

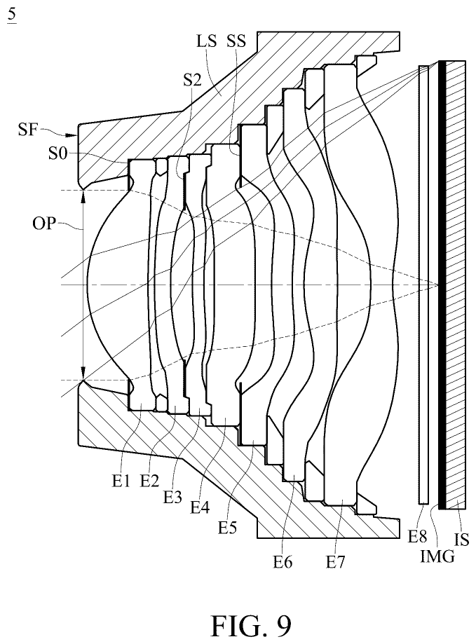

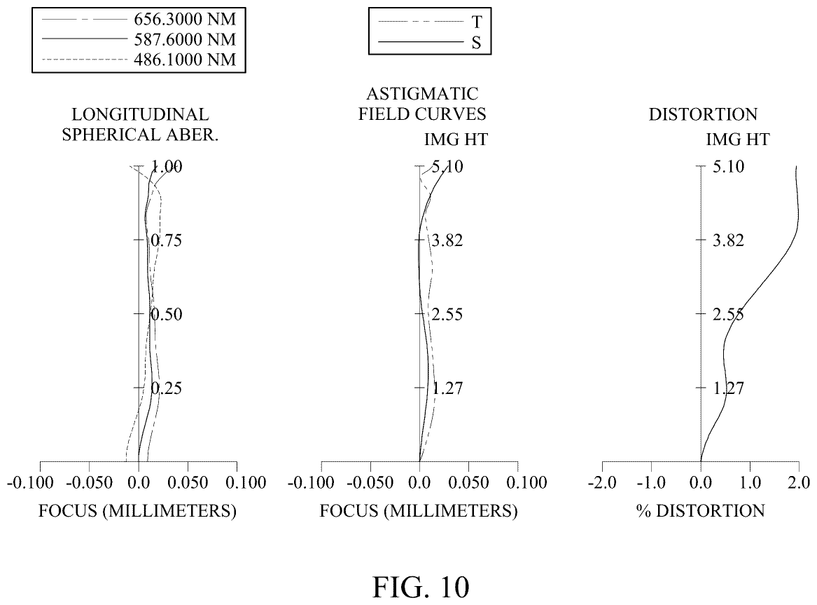

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the optical photography lens system (its reference numeral is omitted) of the present disclosure and an image sensor IS.

The optical photography lens system includes a lens barrel LS, seven lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The seven lens elements are disposed in the lens barrel LS. The seven lens elements are, in order from the object side to an image side along the optical axis, a first lens element E1, a second lens element E2, a third lens element E3, a fourth lens element E4, a fifth lens element E5, a sixth lens element E6 and a seventh lens element E7.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, a stop SS (light-blocking sheet), the fifth lens element E5, the sixth lens element E6, the seventh lens element E7, a filter E8 and an image surface IMG. The optical photography lens system includes seven lens elements (E1, E2, E3, E4, E5, E6 and E7) with no additional lens element disposed between each of the adjacent seven lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of glass material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with negative refractive power has an object-side surface being convex in a paraxial region thereof and an image-side surface being concave in a paraxial region thereof. The fourth lens element E4 is made of glass material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has three inflection points. The object-side surface of the sixth lens element E6 has one critical point in an off-axis region thereof. The image-side surface of the sixth lens element E6 has two critical points in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the optical photography lens system. The image sensor IS is disposed on or near the image surface IMG of the optical photography lens system.

The detailed optical data of the 5th embodiment are shown in Table 5A and the aspheric surface data are shown in Table 5B3 below.

TABLE 5A
5th Embodiment
f = 6.57 mm, Fno = 1.52, HFOV = 37.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 1.038 | | | | |
| 2 | Stop | Plano | | −0.948 | | | | |
| 3 | Lens 1 | 2.7585 | (ASP) | 1.385 | Glass | 1.552 | 63.4 | 5.83 |
| 4 | | 15.8567 | (ASP) | 0.146 | | | | |
| 5 | Lens 2 | 11.3001 | (ASP) | 0.367 | Glass | 1.946 | 17.9 | −13.72 |
| 6 | | 5.9455 | (ASP) | 0.329 | | | | |
| 7 | Stop | Plano | | 0.167 | | | | |
| 8 | Lens 3 | 7.6882 | (ASP) | 0.261 | Plastic | 1.705 | 14.0 | 663.02 |
| 9 | | 7.7071 | (ASP) | 0.239 | | | | |
| 10 | Lens 4 | 138.6745 | (ASP) | 0.926 | Glass | 1.623 | 58.2 | −438.46 |
| 11 | | 91.7431 | (ASP) | −0.317 | | | | |
| 12 | Stop | Plano | | 0.692 | | | | |
| 13 | Lens 5 | 7.7937 | (ASP) | 0.470 | Plastic | 1.551 | 44.5 | −75.64 |
| 14 | | 6.4261 | (ASP) | 0.268 | | | | |
| 15 | Lens 6 | 3.9629 | (ASP) | 0.761 | Plastic | 1.544 | 56.0 | 5.42 |
| 16 | | −10.7395 | (ASP) | 0.756 | | | | |
| 17 | Lens 7 | −7.1347 | (ASP) | 0.498 | Plastic | 1.544 | 56.0 | −3.77 |
| 18 | | 2.9481 | (ASP) | 0.600 | | | | |

| | | | | | | | |
|---|---|---|---|---|---|---|---|
| 19 | Filter | Plano | 0.210 | Glass | 1.517 | 64.2 | — |
| 20 | | Plano | 0.244 | | | | |
| 21 | Image | Plano | — | | | | |

Note:
Reference wavelength is 587.6 nm (d-line).
An effective radius of the stop (the lens-barrel-minimum-opening OP, Surface 1) is 2.170 mm.
An effective radius of the stop (the light-blocking element S0, Surface 2) is 2.161 mm.
An effective radius of the stop (the light-blocking element S2, Surface 7) is 1.715 mm.
An effective radius of the stop SS (the light-blocking sheet, Surface 12) is 2.228 mm.

TABLE 5B
Aspheric Coefficients

| Surface # | 3 | 4 | 5 | 6 |
|---|---|---|---|---|
| k= | 0.000E+00 | 0.000E+00 | 0.000E+00 | 0.000E+00 |
| A4= | −3.98302315E−04 | −9.13734319E−03 | −1.33313523E−02 | −9.52258486E−03 |
| A6= | 8.58221147E−04 | 3.55514591E−03 | 7.53601727E−03 | 1.14930131E−02 |
| A8= | −1.29486688E−03 | 3.03918874E−03 | 2.56890716E−03 | −1.97738532E−02 |
| A10= | 1.15952762E−03 | −7.35296064E−03 | −1.00601795E−02 | 4.09638061E−02 |
| A12= | −6.15499804E−04 | 7.08594446E−03 | 1.22037803E−02 | −5.86671012E−02 |
| A14= | 1.36927129E−04 | −4.20885688E−03 | −9.15864128E−03 | 5.48219405E−02 |
| A16= | 3.85883923E−05 | 1.63917696E−03 | 4.66093310E−03 | −3.35837468E−02 |
| A18= | −3.89833152E−05 | −4.16252379E−04 | −1.62728287E−03 | 1.34050551E−02 |
| A20= | 1.31277373E−05 | 6.55610888E−05 | 3.83963411E−04 | −3.35777613E−03 |
| A22= | −2.35868673E−06 | −5.63026596E−06 | −5.86247365E−05 | 4.79204804E−04 |
| A24= | 2.24370860E−07 | 1.66692655E−07 | 5.24597032E−06 | −2.97142648E−05 |
| A26= | −8.88557520E−09 | 4.50279369E−09 | −2.09813258E−07 | — |
| Surface # | 8 | 9 | 10 | 11 |
| k= | 0.000E+00 | 0.000E+00 | 0.000E+00 | 0.000E+00 |
| A4= | −2.38463498E−02 | −1.78724221E−02 | −1.18480460E−02 | −7.30486140E−03 |
| A6= | 1.42937924E−02 | −1.22554860E−02 | −1.61027479E−02 | −2.31873174E−02 |
| A8= | −5.11636729E−02 | 3.29711198E−02 | 4.52529306E−02 | 4.17520260E−02 |
| A10= | 9.52598407E−02 | −7.08951865E−02 | −9.83788729E−02 | −5.74644071E−02 |
| A12= | −1.17505893E−01 | 1.00747935E−01 | 1.48352766E−01 | 5.70111593E−02 |
| A14= | 9.67450314E−02 | −9.71195658E−02 | −1.54034264E−01 | −4.13192973E−02 |
| A16= | −5.38096799E−02 | 6.41491324E−02 | 1.11579790E−01 | 2.21621848E−02 |
| A18= | 1.99772911E−02 | −2.90540299E−02 | −5.67655750E−02 | −8.83116431E−03 |
| A20= | −4.73665402E−03 | 8.88189762E−03 | 2.01560741E−02 | 2.60088949E−03 |
| A22= | 6.48292409E−04 | −1.75176291E−03 | −4.87920942E−03 | −5.57412460E−04 |
| A24= | −3.89634026E−05 | 2.01088735E−04 | 7.65436624E−04 | 8.43338166E−05 |
| A26= | — | −1.01919777E−05 | −6.99638165E−05 | −8.51937628E−06 |
| A28= | — | — | 2.82131898E−06 | 5.14679829E−07 |
| A30= | — | — | — | −1.40367579E−08 |
| Surface # | 13 | 14 | 15 | 16 |
| k= | 0.000E+00 | 0.000E+00 | −1.000E+00 | 0.000E+00 |
| A4= | 2.10462683E−03 | 9.79063617E−03 | 4.35922757E−02 | 6.10305541E−02 |
| A6= | −5.11795182E−02 | −1.05813884E−01 | −7.69457514E−02 | −3.06945468E−02 |
| A8= | 7.43826854E−02 | 1.21331349E−01 | 5.55911226E−02 | 6.13597926E−03 |
| A10= | −7.11811561E−02 | −8.94124498E−02 | −2.96879869E−02 | 3.74484672E−04 |
| A12= | 4.92367143E−02 | 4.79904983E−02 | 1.18586503E−02 | −5.22567877E−04 |
| A14= | −2.60266991E−02 | −1.95910337E−02 | −3.51230354E−03 | 1.28140276E−04 |
| A16= | 1.06165221E−02 | 6.14398959E−03 | 7.59099013E−04 | −1.44479471E−05 |
| A18= | −3.30784285E−03 | −1.47317061E−03 | −1.18254248E−04 | 3.91748528E−07 |
| A20= | 7.70787217E−04 | 2.66197881E−04 | 1.31589861E−05 | 1.04916153E−07 |
| A22= | −1.30393850E−04 | −3.53655255E−05 | −1.03252473E−06 | −1.56787486E−08 |
| A24= | 1.53708376E−05 | 3.32526225E−06 | 5.57005863E−08 | 1.07654421E−09 |
| A26= | −1.18551229E−06 | −2.08161726E−07 | −1.96455250E−09 | −4.18791412E−11 |
| A28= | 5.33259709E−08 | 7.74737277E−09 | 4.07766987E−11 | 8.90875019E−13 |
| A30= | −1.05243993E−09 | −1.29288372E−10 | −3.77649957E−13 | −8.08630768E−15 |

| Surface # | 17 | 18 |
|---|---|---|
| k= | 0.000E+00 | −1.000E+00 |
| A4= | −6.18169991E−02 | −9.15888395E−02 |
| A6= | 6.17118970E−03 | 2.93851838E−02 |
| A8= | 6.42535747E−03 | −7.73658907E−03 |
| A10= | −3.30745358E−03 | 1.77811661E−03 |
| A12= | 8.81966355E−04 | −3.43988857E−04 |
| A14= | −1.54778701E−04 | 5.20418317E−05 |
| A16= | 1.89842241E−05 | −5.88449946E−06 |
| A18= | −1.66505089E−06 | 4.87584154E−07 |
| A20= | 1.05085363E−07 | −2.92690356E−08 |
| A22= | −4.73635346E−09 | 1.25387268E−09 |
| A24= | 1.48765991E−10 | −3.72910024E−11 |
| A26= | −3.09355008E−12 | 7.30579738E−13 |
| A28= | 3.82756360E−14 | −8.47041221E−15 |
| A30= | −2.13291949E−16 | 4.39956202E−17 |

In the 5th embodiment, the equation of the aspheric surface profiles of the aforementioned lens elements is the same as the equation of the 1st embodiment. Also, the definitions of these parameters shown in Table 5C are the same as those stated in the 1 st embodiment with corresponding values for the 5th embodiment, so an explanation in this regard will not be provided again.

Moreover, these parameters can be calculated from Table 5A and Table 5B as the following values and satisfy the following conditions:

TABLE 5C
Schematic Parameters

| | | | |
|---|---|---|---|
| f [mm] | 6.57 | T23/CT2 | 1.35 |
| Fno | 1.52 | T34/CT2 | 0.65 |
| HFOV [deg.] | 37.2 | T56/T45 | 0.71 |
| FOV [deg.] | 74.4 | V1-V2 | 45.5 |
| f/f1 | 1.13 | V4-V3 | 44.2 |
| f1/f45 | −0.09 | Dbs0/Ys0 | 0.53 |
| R11/R12 | −0.37 | (Y3R2-Y2R2)/(Y4R2-Y3R2) | 0.19 |
| R14/R13 | −0.41 | (Y5R1-Y4R2)/(Y6R1-Y5R2) | 0.33 |
| DbR1 [mm] | 0.20 | ET1/ET2 | 1.06 |
| DsR2/DbR2 | 0.28 | ET1/ET5 | 1.01 |
| CT1/ST1 | 2.95 | ST7/ST6 | 2.22 |
| CT2/CT1 | 0.26 | SAG3R1/SAG2R2 | −0.32 |
| CT3/CT1 | 0.19 | SAG3R2/SAG4R2 | 0.09 |
| CT4/CT1 | 0.67 | SAG5R1/CT5 | −1.04 |
| Ys0/ImgH | 0.42 | Ys0/Ybo | 1.00 |
| T12/CT3 | 0.56 | — | — |

### 6th Embodiment

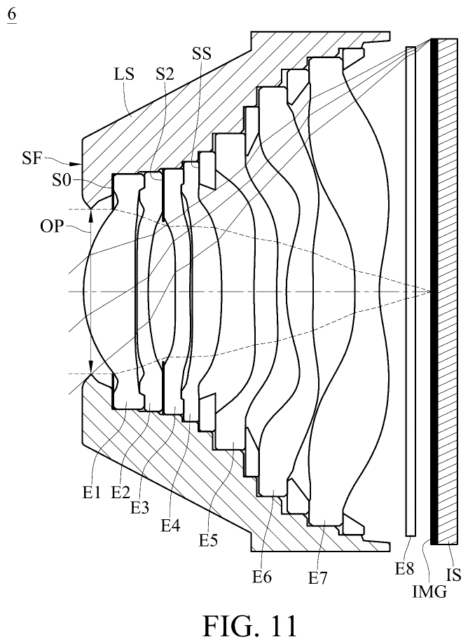

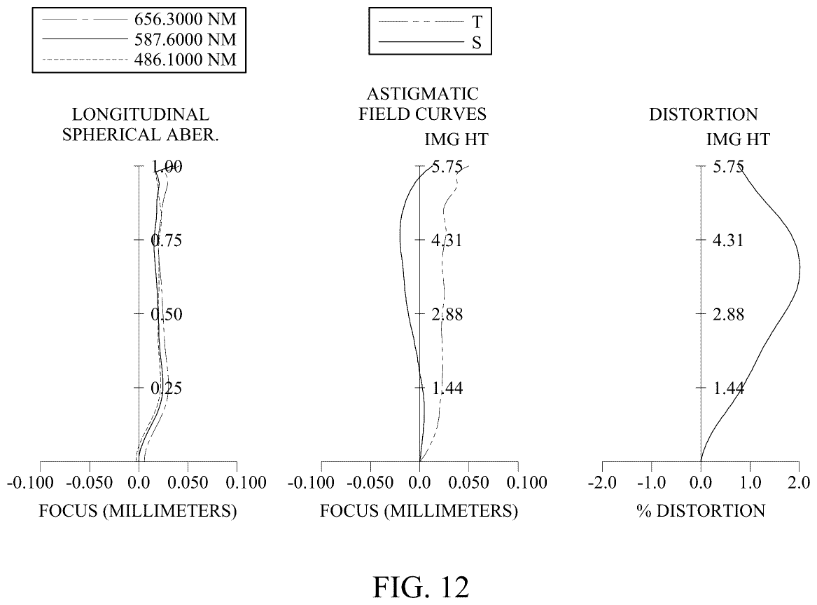

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the optical photography lens system (its reference numeral is omitted) of the present disclosure and an image sensor IS.

The optical photography lens system includes a lens barrel LS, seven lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The seven lens elements are disposed in the lens barrel LS. The seven lens elements are, in order from the object side to an image side along the optical axis, a first lens element E1, a second lens element E2, a third lens element E3, a fourth lens element E4, a fifth lens element E5, a sixth lens element E6 and a seventh lens element E7.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, a stop SS (spacer), the fifth lens element E5, the sixth lens element E6, the seventh lens element E7, a filter E8 and an image surface IMG. The optical photography lens system includes seven lens elements (E1, E2, E3, E4, E5, E6 and E7) with no additional lens element disposed between each of the adjacent seven lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point. The image-side surface of the first lens element E1 has two inflection points. The image-side surface of the first lens element E1 has one critical point in an off-axis region thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The object-side surface of the second lens element E2 has one critical point in an off-axis region thereof.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has three inflection points. The object-side surface of the sixth lens element E6 has one critical point in an off-axis region thereof. The image-side surface of the sixth lens element E6 has two critical points in an off-axis region thereof.

The seventh lens element E7 with negative refractive power has an object-side surface being concave in a paraxial region thereof and an image-side surface being concave in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The filter E8 is made of glass material and located between the seventh lens element E7 and the image surface IMG, and will not affect the focal length of the optical photography lens system. The image sensor IS is disposed on or near the image surface IMG of the optical photography lens system.

The detailed optical data of the 6th embodiment are shown in Table 6A and the aspheric surface data are shown in Table 6B below.

TABLE 6A
6th Embodiment
f = 6.22 mm, Fno = 1.66, HFOV = 42.5 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.501 | | | | |
| 2 | Stop | Plano | | −0.668 | | | | |
| 3 | Lens 1 | 2.8526 | (ASP) | 1.177 | Plastic | 1.511 | 56.8 | |
| 4 | | −99.8629 | (ASP) | 0.043 | | | | |
| 5 | Lens 2 | −86.1340 | (ASP) | 0.251 | Plastic | 1.587 | 28.3 | −11.30 |
| 6 | | 7.1955 | (ASP) | 0.356 | | | | |
| 7 | Stop | Plano | | 0.261 | | | | |
| 8 | Lens 3 | 43.5905 | (ASP) | 0.335 | Plastic | 1.705 | 14.0 | −27.73 |
| 9 | | 13.4495 | (ASP) | 0.050 | | | | |
| 10 | Lens 4 | 30.3859 | (ASP) | 0.670 | Plastic | 1.544 | 56.0 | 15.88 |
| 11 | | −11.9794 | (ASP) | −0.141 | | | | |
| 12 | Stop | Plano | | 0.878 | | | | |
| 13 | Lens 5 | 13.3934 | (ASP) | 0.515 | Plastic | 1.566 | 37.4 | −44.90 |
| 14 | | 8.6494 | (ASP) | 0.221 | | | | |
| 15 | Lens 6 | 4.1448 | (ASP) | 0.612 | Plastic | 1.544 | 56.0 | 5.61 |
| 16 | | −10.9945 | (ASP) | 0.949 | | | | |
| 17 | Lens 7 | −10.7570 | (ASP) | 0.554 | Plastic | 1.544 | 56.0 | −3.99 |
| 18 | | 2.7673 | (ASP) | 0.610 | | | | |

| | | | | | | | |
|---|---|---|---|---|---|---|---|
| 19 | Filter | Plano | 0.210 | Glass | 1.517 | 64.2 | — |
| 20 | | Plano | 0.356 | | | | |
| 21 | Image | Plano | — | | | | |

Note:
Reference wavelength is 587.6 nm (d-line).
An effective radius of the stop (the lens-barrel-minimum-opening OP, Surface 1) is 1.883 mm.
An effective radius of the stop (the light-blocking element S0, Surface 2) is 1.873 mm.
An effective radius of the stop (the light-blocking element S2, Surface 7) is 1.598 mm.
An effective radius of the stop SS (the spacer, Surface 12) is 2.315 mm.

TABLE 6B
Aspheric Coefficients

| Surface # | 3 | 4 | 5 | 6 |
|---|---|---|---|---|
| k= | 0.000E+00 | 0.000E+00 | 0.000E+00 | 0.000E+00 |
| A4= | −7.73882002E−04 | 2.30025061E−03 | 1.67703254E−03 | 1.14613110E−03 |
| A6= | 3.33412227E−03 | 3.23320727E−03 | 1.33045501E−02 | 1.04909183E−03 |
| A8= | −5.49089218E−03 | 7.29580944E−03 | −1.81864730E−02 | 6.32495164E−03 |
| A10= | 4.49566324E−03 | −2.46615139E−02 | 2.48803428E−02 | −1.64537755E−02 |
| A12= | 2.87480681E−04 | 3.62978391E−02 | −3.12923577E−02 | 1.96848908E−02 |
| A14= | −4.44432245E−03 | −3.49108705E−02 | 2.95584430E−02 | −1.34452453E−02 |
| A16= | 4.70512252E−03 | 2.36737188E−02 | −1.90545187E−02 | 5.19402732E−03 |
| A18= | −2.63490667E−03 | −1.12973924E−02 | 8.22170370E−03 | −8.27108102E−04 |
| A20= | 8.94944459E−04 | 3.68102864E−03 | −2.32427171E−03 | −1.26750546E−04 |
| A22= | −1.84960559E−04 | −7.71838658E−04 | 4.11967893E−04 | 7.13793836E−05 |
| A24= | 2.14657257E−05 | 9.28629367E−05 | −4.15086300E−05 | −8.15511667E−06 |
| A26= | −1.07594834E−06 | −4.82642493E−06 | 1.80487458E−06 | — |
| Surface # | 8 | 9 | 10 | 11 |
| k= | 0.000E+00 | 0.000E+00 | 0.000E+00 | 0.000E+00 |
| A4= | −3.13459462E−02 | −3.49570076E−02 | −2.47061608E−02 | −1.09527942E−02 |
| A6= | 1.48696776E−02 | 3.59178307E−02 | 3.86671621E−02 | −2.30571563E−02 |
| A8= | −4.35636488E−02 | −7.81952071E−02 | −7.69008254E−02 | 7.31897897E−02 |
| A10= | 6.44199225E−02 | 1.08525519E−01 | 9.84786642E−02 | −1.49896071E−01 |
| A12= | −6.47254000E−02 | −1.06912719E−01 | −8.37433134E−02 | 2.06107848E−01 |
| A14= | 4.39195189E−02 | 7.59720205E−02 | 4.66617158E−02 | −1.98248058E−01 |
| A16= | −2.00343917E−02 | −3.88795119E−02 | −1.54108599E−02 | 1.36831512E−01 |
| A18= | 6.00673397E−03 | 1.41751468E−02 | 1.65429961E−03 | −6.85961523E−02 |
| A20= | −1.11695338E−03 | −3.58409880E−03 | 9.11675858E−04 | 2.49980166E−02 |
| A22= | 1.14310533E−04 | 5.95681439E−04 | −4.73496715E−04 | −6.54934279E−03 |
| A24= | −4.69390283E−06 | −5.83085603E−05 | 1.02253234E−04 | 1.20088779E−03 |
| A26= | — | 2.53426148E−06 | −1.11514360E−05 | −1.46151693E−04 |
| A28= | — | — | 5.00203770E−07 | 1.05960674E−05 |
| A30= | — | — | — | −3.46022591E−07 |
| Surface # | 13 | 14 | 15 | 16 |
| k= | 0.000E+00 | 0.000E+00 | −1.000E+00 | 0.000E+00 |
| A4= | −1.12772423E−02 | −8.98569313E−03 | 4.32231493E−02 | 6.38219773E−02 |
| A6= | −1.18439639E−02 | −5.40497721E−02 | −5.12401184E−02 | −1.17794023E−02 |
| A8= | 1.86992176E−02 | 5.14897281E−02 | 3.00785767E−02 | −5.51819099E−03 |
| A10= | −1.69737157E−02 | −2.96595513E−02 | −1.33148833E−02 | 4.17221644E−03 |
| A12= | 1.11114940E−02 | 1.24810965E−02 | 4.28296782E−03 | −1.43389996E−03 |
| A14= | −5.88561527E−03 | −4.21396512E−03 | −1.00361401E−03 | 3.20722956E−04 |
| A16= | 2.52071834E−03 | 1.19068330E−03 | 1.71755869E−04 | −5.05448899E−05 |
| A18= | −8.35100768E−04 | −2.77568717E−04 | −2.14997765E−05 | 5.77856952E−06 |
| A20= | 2.04886639E−04 | 5.07278183E−05 | 1.97054639E−06 | −4.83125148E−07 |
| A22= | −3.59372749E−05 | −6.85940571E−06 | −1.31540040E−07 | 2.93025672E−08 |
| A24= | 4.34201126E−06 | 6.49294915E−07 | 6.26559761E−09 | −1.25609392E−09 |
| A26= | −3.41626220E−07 | −4.02720548E−08 | −2.02790805E−10 | 3.60742090E−11 |
| A28= | 1.57084779E−08 | 1.46287619E−09 | 4.00509269E−12 | −6.22331114E−13 |
| A30= | −3.19538930E−10 | −2.35361851E−11 | −3.64083292E−14 | 4.87039950E−15 |

| Surface # | 17 | 18 |
|---|---|---|
| k= | 0.000E+00 | −1.000E+00 |
| A4= | −5.13274363E−02 | −7.39413457E−02 |
| A6= | 1.24147158E−02 | 2.40123733E−02 |
| A8= | −2.60161669E−03 | −6.92268339E−03 |
| A10= | 7.18605053E−04 | 1.60547377E−03 |
| A12= | −1.59578371E−04 | −2.82648409E−04 |
| A14= | 2.41950040E−05 | 3.68814952E−05 |
| A16= | −2.55568047E−06 | −3.55305212E−06 |
| A18= | 1.93760882E−07 | 2.52810163E−07 |
| A20= | −1.06867730E−08 | −1.32322155E−08 |
| A22= | 4.26870525E−10 | 5.02589502E−10 |
| A24= | −1.20518128E−11 | −1.34611349E−11 |
| A26= | 2.28140860E−13 | 2.40742001E−13 |
| A28= | −2.59635904E−15 | −2.57685660E−15 |
| A30= | 1.34106928E−17 | 1.24690648E−17 |

In the 6th embodiment, the equation of the aspheric surface profiles of the aforementioned lens elements is the same as the equation of the 1st embodiment. Also, the definitions of these parameters shown in Table 6C are the same as those stated in the 1 st embodiment with corresponding values for the 6th embodiment, so an explanation in this regard will not be provided again.

Moreover, these parameters can be calculated from Table 6A and Table 6B as the following values and satisfy the following conditions:

TABLE 6C
Schematic Parameters

| | | | |
|---|---|---|---|
| f [mm] | 6.22 | T23/CT2 | 2.46 |
| Fno | 1.66 | T34/CT2 | 0.20 |
| HFOV [deg.] | 42.5 | T56/T45 | 0.30 |
| FOV [deg.] | 85.0 | V1-V2 | 28.5 |
| f/f1 | 1.14 | V4-V3 | 42.0 |
| f1/f45 | 0.24 | Dbs0/Ys0 | 0.36 |
| R11/R12 | −0.38 | (Y3R2-Y2R2)/(Y4R2-Y3R2) | 0.95 |
| R14/R13 | −0.26 | (Y5R1-Y4R2)/(Y6R1-Y5R2) | 0.92 |
| DbR1 [mm] | 0.03 | ET1/ET2 | 1.46 |
| DsR2/DbR2 | 0.43 | ET1/ET5 | 1.39 |
| CT1/ST1 | 2.22 | ST7/ST6 | 2.86 |
| CT2/CT1 | 0.21 | SAG3R1/SAG2R2 | −0.95 |
| CT3/CT1 | 0.28 | SAG3R2/SAG4R2 | 0.29 |
| CT4/CT1 | 0.57 | SAG5R1/CT5 | −1.10 |
| Ys0/ImgH | 0.33 | Ys0/Ybo | 0.99 |
| T12/CT3 | 0.13 | — | — |

### 7th Embodiment

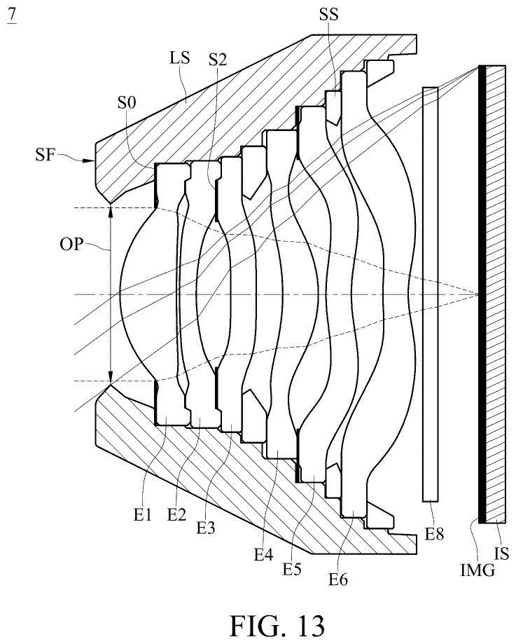

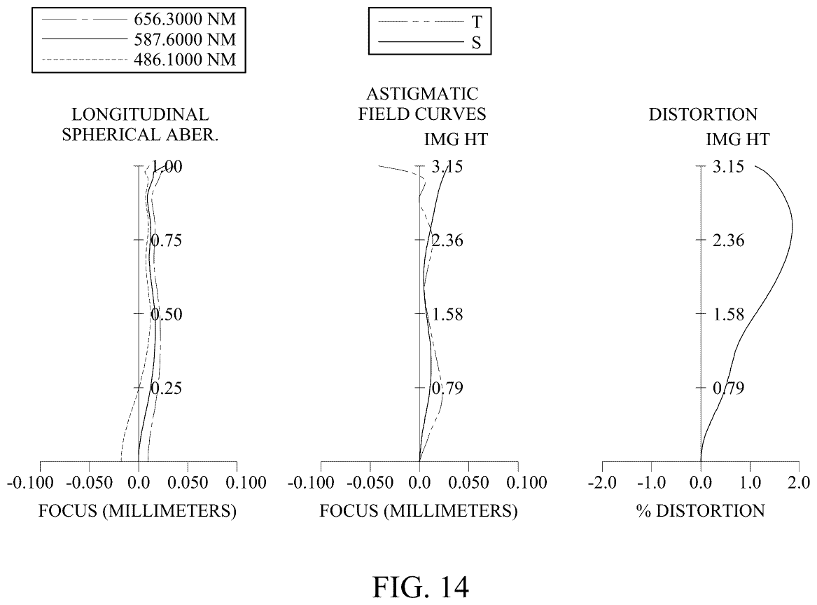

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the optical photography lens system (its reference numeral is omitted) of the present disclosure and an image sensor IS.

The optical photography lens system includes a lens barrel LS, six lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The six lens elements are disposed in the lens barrel LS. The six lens elements are, in order from the object side to an image side along the optical axis, a first lens element E1, a second lens element E2, a third lens element E3, a fourth lens element E4, a fifth lens element E5 and a sixth lens element E6.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, the fifth lens element E5, a stop SS (spacer), the sixth lens element E6, a filter E8 and an image surface IMG. The optical photography lens system includes six lens elements (E1, E2, E3, E4, E5 and E6) with no additional lens element disposed between each of the adjacent six lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has two inflection points. The object-side surface of the third lens element E3 has one critical point in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has two inflection points. The object-side surface of the sixth lens element E6 has one critical point in an off-axis region thereof. The image-side surface of the sixth lens element E6 has one critical point in an off-axis region thereof.

The filter E8 is made of glass material and located between the sixth lens element E6 and the image surface IMG, and will not affect the focal length of the optical photography lens system. The image sensor IS is disposed on or near the image surface IMG of the optical photography lens system.

The detailed optical data of the 7th embodiment are shown in Table 7A and the aspheric surface data are shown in Table 7B below.

TABLE 7A
7th Embodiment
f = 4.22 mm, Fno = 1.76, HFOV = 36.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.630 | | | | |
| 2 | Stop | Plano | | −0.501 | | | | |
| 3 | Lens 1 | 1.6088 | (ASP) | 0.782 | Plastic | 1.545 | 56.1 | 3.37 |
| 4 | | 10.8322 | (ASP) | 0.042 | | | | |
| 5 | Lens 2 | 6.6183 | (ASP) | 0.232 | Plastic | 1.660 | 20.4 | −7.78 |
| 6 | | 2.8515 | (ASP) | 0.280 | | | | |
| 7 | Stop | Plano | | 0.195 | | | | |
| 8 | Lens 3 | 47.5947 | (ASP) | 0.353 | Plastic | 1.660 | 20.4 | 248.12 |
| 9 | | 66.8991 | (ASP) | 0.368 | | | | |
| 10 | Lens 4 | −2.8350 | (ASP) | 0.492 | Plastic | 1.544 | 56.0 | 7.19 |
| 11 | | −1.7447 | (ASP) | 0.106 | | | | |
| 12 | Lens 5 | 2.3717 | (ASP) | 0.351 | Plastic | 1.639 | 23.3 | −79.61 |
| 13 | | 2.1353 | (ASP) | −0.200 | | | | |
| 14 | Stop | Plano | | 0.637 | | | | |
| 15 | Lens 6 | 3.4144 | (ASP) | 0.350 | Plastic | 1.511 | 56.8 | −5.04 |
| 16 | | 1.4174 | (ASP) | 0.200 | | | | |

| | | | | | | | |
|---|---|---|---|---|---|---|---|
| 17 | Filter | Plano | 0.210 | Glass | 1.517 | 64.2 | — |
| 18 | | Plano | 0.570 | | | | |
| 19 | Image | Plano | — | | | | |

Note:
Reference wavelength is 587.6 nm (d-line).
An effective radius of the stop (the lens-barrel-minimum-opening OP, Surface 1) is 1.250 mm.
An effective radius of the stop (the light-blocking element S0, Surface 2) is 1.198 mm.
An effective radius of the stop (the light-blocking element S2, Surface 7) is 1.010 mm.
An effective radius of the stop SS (the spacer, Surface 14) is 2.333 mm.

TABLE 7B
Aspheric Coefficients

| Surface # | 3 | 4 | 5 | 6 |
|---|---|---|---|---|
| k= | −4.05853E−02 | −1.69565E−01 | −4.44591E+01 | −9.90521E+00 |
| A4= | −4.64410177E−04 | −1.59901423E−01 | −1.95521041E−01 | −4.93473071E−02 |
| A6= | 2.00296259E−02 | 4.79088920E−01 | 6.23558647E−01 | 3.02447442E−01 |
| A8= | −6.79678680E−02 | −6.99441535E−01 | −9.15260681E−01 | −5.90152768E−01 |
| A10= | 1.36712489E−01 | 5.56616861E−01 | 7.79614124E−01 | 8.27265722E−01 |
| A12= | −1.54211407E−01 | −2.45838606E−01 | −3.56833535E−01 | −6.68805624E−01 |
| A14= | 8.98273443E−02 | 4.46043490E−02 | 7.07669287E−02 | 2.56100508E−01 |
| A16= | −2.25230897E−02 | — | — | — |
| Surface # | 8 | 9 | 10 | 11 |
| k= | 3.50544E+01 | 9.00000E+01 | −1.12795E+00 | −1.03531E+00 |
| A4= | −1.78540819E−01 | −1.11614727E−01 | 5.86010890E−02 | −4.97255500E−02 |
| A6= | 7.29524902E−02 | −5.53732626E−02 | −9.23485180E−02 | 3.93661312E−02 |
| A8= | −4.35433987E−01 | 1.07382317E−01 | 1.04790303E−01 | 1.40379682E−02 |
| A10= | 9.93083121E−01 | −1.36056550E−01 | −4.22237431E−02 | −3.84580299E−03 |
| A12= | −1.36690113E+00 | 9.87172019E−02 | 6.05588204E−03 | −1.84558817E−03 |
| A14= | 1.00892347E+00 | −2.18773272E−02 | −1.35484311E−04 | 4.95832892E−04 |
| A16= | −2.82704213E−01 | — | — | −1.68988363E−05 |
| Surface # | 12 | 13 | 15 | 16 |
| k= | 4.94355E−01 | −3.18064E+00 | −5.88582E+01 | −9.87786E+00 |
| A4= | −2.05732713E−01 | −1.57312870E−01 | −3.66254523E−01 | −2.09315552E−01 |
| A6= | 3.30180678E−02 | 3.22053889E−02 | 2.58907964E−01 | 1.38376398E−01 |
| A8= | 2.71434297E−02 | 2.27503337E−02 | −1.05226776E−01 | −5.64312034E−02 |
| A10= | −2.17896774E−02 | −2.06693468E−02 | 2.67934702E−02 | 1.41620105E−02 |
| A12= | 2.61025810E−03 | 6.55227000E−03 | −4.09111029E−03 | −2.13201405E−03 |
| A14= | 1.19676323E−03 | −9.26317872E−04 | 3.39179393E−04 | 1.74033757E−04 |
| A16= | −2.47941955E−04 | 4.86360744E−05 | −1.16782896E−05 | −5.82157473E−06 |

In the 7th embodiment, the equation of the aspheric surface profiles of the aforementioned lens elements is the same as the equation of the 1st embodiment. Also, the definitions of these parameters shown in Table 7C are the same as those stated in the 1 st embodiment with corresponding values for the 7th embodiment, so an explanation in this regard will not be provided again.

Moreover, these parameters can be calculated from Table 7A and Table 7B as the following values and satisfy the following conditions:

TABLE 7C
Schematic Parameters

| | | | |
|---|---|---|---|
| f [mm] | 4.22 | T23/CT2 | 2.05 |
| Fno | 1.76 | T34/CT2 | 1.59 |
| HFOV [deg.] | 36.4 | T56/T45 | 4.12 |
| FOV [deg.] | 72.8 | V1-V2 | 35.7 |
| f/f1 | 1.25 | V4-V3 | 35.6 |
| f1/f45 | 0.45 | Dbs0/Ys0 | 0.69 |
| R11/R12 | 2.41 | (Y3R2-Y2R2)/(Y4R2-Y3R2) | 0.41 |
| R14/R13 | — | (Y5R1-Y4R2)/(Y6R1-Y5R2) | 1.13 |
| DbR1 [mm] | 0.34 | ET1/ET2 | 0.77 |
| DsR2/DbR2 | 0.27 | ET1/ET5 | 0.70 |
| CT1/ST1 | 2.63 | ST7/ST6 | — |
| CT2/CT1 | 0.30 | SAG3R1/SAG2R2 | −0.81 |
| CT3/CT1 | 0.45 | SAG3R2/SAG4R2 | 0.41 |
| CT4/CT1 | 0.63 | SAG5R1/CT5 | −0.92 |
| Ys0/ImgH | 0.38 | Ys0/Ybo | 0.96 |
| T12/CT3 | 0.12 | — | — |

### 8th Embodiment

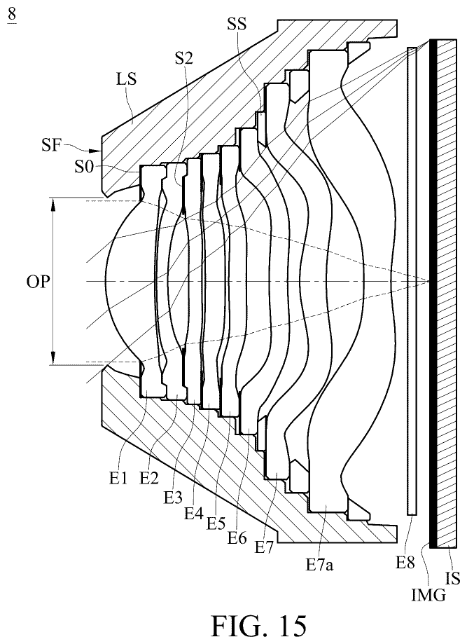

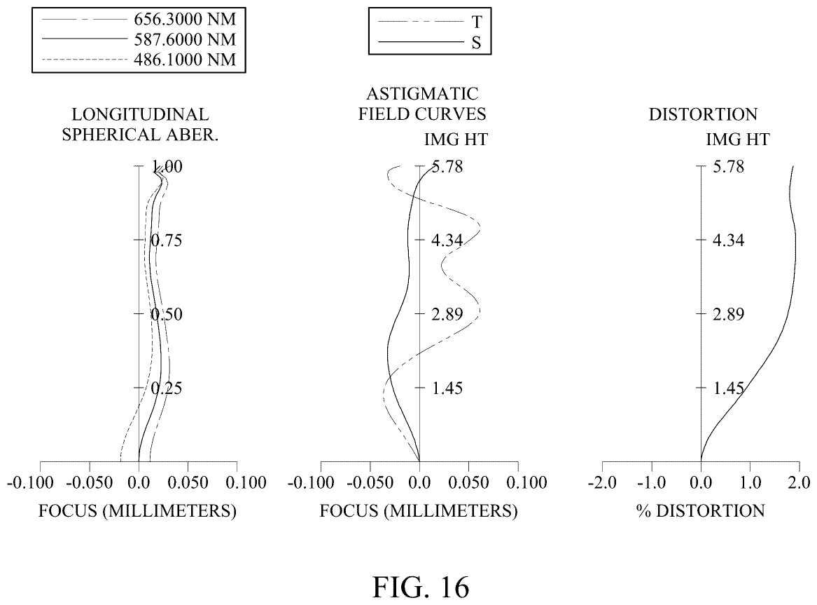

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the optical photography lens system (its reference numeral is omitted) of the present disclosure and an image sensor IS.

The optical photography lens system includes a lens barrel LS, eight lens elements and a plurality of light-blocking elements S0 and S2.

An annular surface of the lens barrel LS closest to an object side and facing towards the object side is a lens-barrel-object-end outer surface. Moreover, the lens-barrel-object-end outer surface surrounds an optical axis. Moreover, the lens barrel LS has a most-object-end SF located on the lens-barrel-object-end outer surface and served as an endpoint of the lens barrel LS closest to the object side. Moreover, the lens barrel LS further has a lens-barrel-minimum-opening OP located on an object side of the light-blocking elements S0 and S2.

The eight lens elements are disposed in the lens barrel LS. The eight lens elements are, in order from the object side to an image side along the optical axis, a first lens element E1, a second lens element E2, a third lens element E3, a fourth lens element E4, a fifth lens element E5, a sixth lens element E6, a seventh lens element E7 and an eighth lens element E7a.

The light-blocking elements S0 and S2 are located in the lens barrel LS. The light-blocking element S0 has an object-side surface facing towards the object side, an image-side surface facing towards the image side, a minimum opening located between the object-side surface and the image-side surface of the light-blocking element S0, and a bore surface connected to and located between the object-side surface and the image-side surface of the light-blocking element S0. Moreover, the light-blocking element S0 further has a most-object-end located on the object-side surface and served as an endpoint of the light-blocking element S0 closest to the object side. Moreover, the light-blocking element S2 has a similar configuration with that of the light-blocking element S0.

The optical photography lens system includes, in order from the object side to the image side along the optical axis, the most-object-end SF, the light-blocking element S0, the first lens element E1, the second lens element E2, the light-blocking element S2, the third lens element E3, the fourth lens element E4, the fifth lens element E5, the sixth lens element E6, a stop SS (spacer), the seventh lens element E7, the eighth lens element E7a, a filter E8 and an image surface IMG. The optical photography lens system includes eight lens elements (E1, E2, E3, E4, E5, E6, E7 and E7a) with no additional lens element disposed between each of the adjacent eight lens elements.

In this embodiment, except for the said stop SS, each of the lens-barrel-minimum-opening OP and the light-blocking elements S0 and S2 is served as a stop of the optical photography lens system.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The image-side surface of the first lens element E1 has one inflection point. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has two inflection points. The image-side surface of the third lens element E3 has two inflection points. The object-side surface of the third lens element E3 has one critical point in an off-axis region thereof. The image-side surface of the third lens element E3 has two critical points in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has one critical point in an off-axis region thereof. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric. The object-side surface of the sixth lens element E6 has two inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E7a with negative refractive power has an object-side surface being concave in a paraxial region thereof and an image-side surface being concave in a paraxial region thereof. The eighth lens element E7a is made of plastic material and has the object-side surface and the image-side surface being both aspheric. The object-side surface of the eighth lens element E7a has one inflection point. The image-side surface of the eighth lens element E7a has two inflection points. The object-side surface of the eighth lens element E7a has one critical point in an off-axis region thereof. The image-side surface of the eighth lens element E7a has one critical point in an off-axis region thereof.

The filter E8 is made of glass material and located between the eighth lens element E7a and the image surface IMG, and will not affect the focal length of the optical photography lens system. The image sensor IS is disposed on or near the image surface IMG of the optical photography lens system.

The detailed optical data of the 8th embodiment are shown in Table 8A and the aspheric surface data are shown in Table 8B below.

TABLE 8A
8th Embodiment
f = 6.54 mm, Fno = 1.70, HFOV = 40.9 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Stop | Plano | | 0.810 | | | | |
| 2 | Stop | Plano | | −0.853 | | | | |
| 3 | Lens 1 | 2.5706 | (ASP) | 1.177 | Plastic | 1.545 | 56.1 | 5.67 |
| 4 | | 12.8410 | (ASP) | 0.047 | | | | |
| 5 | Lens 2 | 12.1260 | (ASP) | 0.269 | Plastic | 1.686 | 18.4 | −15.84 |
| 6 | | 5.6791 | (ASP) | 0.374 | | | | |
| 7 | Stop | Plano | | 0.125 | | | | |
| 8 | Lens 3 | 19.5640 | (ASP) | 0.316 | Plastic | 1.686 | 18.4 | −125.49 |
| 9 | | 15.8367 | (ASP) | 0.083 | | | | |
| 10 | Lens 4 | −22.0380 | (ASP) | 0.480 | Plastic | 1.544 | 56.0 | 148.78 |
| 11 | | −17.4547 | (ASP) | 0.083 | | | | |
| 12 | Lens 5 | 15.4761 | (ASP) | 0.422 | Plastic | 1.544 | 56.0 | 54.21 |
| 13 | | 32.2511 | (ASP) | 0.546 | | | | |
| 14 | Lens 6 | 9.5217 | (ASP) | 0.441 | Plastic | 1.566 | 37.4 | −29.75 |
| 15 | | 5.9805 | (ASP) | −0.520 | | | | |
| 16 | Stop | Plano | | 0.810 | | | | |
| 17 | Lens 7 | 2.9269 | (ASP) | 0.639 | Plastic | 1.544 | 56.0 | 8.89 |
| 18 | | 6.8445 | (ASP) | 0.900 | | | | |
| 19 | Lens 8 | −11.6488 | (ASP) | 0.649 | Plastic | 1.534 | 55.9 | −5.59 |
| 20 | | 4.0890 | (ASP) | 0.400 | | | | |

| | | | | | | | |
|---|---|---|---|---|---|---|---|
| 21 | Filter | Plano | 0.210 | Glass | 1.517 | 64.2 | — |
| 22 | | Plano | 0.325 | | | | |
| 23 | Image | Plano | — | | | | |

Note:
Reference wavelength is 587.6 nm (d-line).
An effective radius of the stop (the lens-barrel-minimum-opening OP, Surface 1) is 2.007 mm.
An effective radius of the stop (the light-blocking element S0, Surface 2) is 1.926 mm.
An effective radius of the stop (the light-blocking element S2, Surface 7) is 1.611 mm.
An effective radius of the stop SS (the spacer, Surface 16) is 3.213 mm.

TABLE 8B
Aspheric Coefficients

| Surface # | 3 | 4 | 5 | 6 |
|---|---|---|---|---|
| k= | −5.54070E−01 | −7.48228E+01 | 3.42391E+01 | 8.08904E+00 |
| A4= | −1.22065663E−03 | −4.46813460E−03 | −1.70043795E−02 | −1.20164552E−02 |
| A6= | 1.01646092E−02 | 3.98973078E−03 | 1.83553527E−02 | 1.59198254E−02 |
| A8= | −8.37988815E−03 | 3.86566659E−03 | −8.16212990E−03 | −1.28176273E−02 |
| A10= | 4.33182845E−03 | −6.04069946E−03 | 5.44098530E−04 | 6.28438100E−03 |
| A12= | −1.30892897E−03 | 3.09207852E−03 | 1.04372168E−03 | −1.59296100E−03 |
| A14= | 2.19649252E−04 | −7.15006523E−04 | −3.53631614E−04 | 1.93454463E−04 |
| A16= | −1.63796440E−05 | 6.16079038E−05 | 3.42181588E−05 | — |
| Surface # | 8 | 9 | 10 | 11 |
| k= | 4.43890E+01 | 2.82144E+01 | −1.03541E+01 | 3.12382E+01 |
| A4= | −2.28822195E−02 | −8.55295339E−03 | 3.74708530E−02 | 5.01983152E−02 |
| A6= | −2.40206147E−02 | −4.23109804E−02 | −8.63844085E−02 | −1.00044168E−01 |
| A8= | 3.66997830E−02 | 5.63408612E−02 | 1.21110679E−01 | 9.16833868E−02 |
| A10= | −3.14389010E−02 | −4.82190620E−02 | −1.11783507E−01 | −4.82397027E−02 |
| A12= | 1.52826905E−02 | 2.43122216E−02 | 6.12692279E−02 | 1.23272338E−02 |
| A14= | −3.79994591E−03 | −6.38530614E−03 | −1.91103120E−02 | −1.76742755E−04 |
| A16= | 3.78098535E−04 | 7.60437182E−04 | 3.15949513E−03 | −7.05415253E−04 |
| A18= | — | −2.55600325E−05 | −2.15651647E−04 | 1.62852804E−04 |
| A20= | — | — | — | −1.20044810E−05 |
| Surface # | 12 | 13 | 14 | 15 |
| k= | −2.75084E+01 | −9.52960E+01 | 1.78036E+00 | −6.37693E+01 |
| A4= | 4.71702916E−02 | 5.49958825E−03 | −1.61793988E−02 | −2.84692423E−02 |
| A6= | −1.17475413E−01 | −2.73016071E−02 | 8.24765145E−03 | 1.40150544E−02 |
| A8= | 1.01909409E−01 | 1.08782557E−02 | −7.50325877E−03 | −7.58025386E−03 |
| A10= | −5.33110195E−02 | −4.80865915E−04 | 2.43114323E−03 | 2.21016021E−03 |
| A12= | 1.65432193E−02 | −1.44233129E−03 | −3.94625306E−04 | −3.82385414E−04 |
| A14= | −2.87762753E−03 | 6.49536450E−04 | 2.72058818E−05 | 4.29263022E−05 |
| A16= | 2.48112706E−04 | −1.25504468E−04 | 1.64018080E−07 | −3.13628320E−06 |
| A18= | −6.15722328E−06 | 1.15000683E−05 | −6.86363898E−08 | 1.34008337E−07 |
| A20= | −2.57755020E−07 | −4.07560503E−07 | −4.96364287E−10 | −2.47526594E−09 |

| Surface # | 17 | 18 | 19 | 20 |
|---|---|---|---|---|
| k= | −1.23687E+00 | −1.72067E+01 | 4.14818E+00 | −4.55125E−01 |
| A4= | −4.16637446E−02 | 1.57357495E−02 | −4.8290109E−02 | −5.09393248E−02 |
| A6= | 9.74054042E−03 | −1.37264669E−02 | 9.5606541E−03 | 1.03915875E−02 |
| A8= | −5.46570726E−03 | 3.54051093E−03 | −1.1743733E−03 | −1.67081076E−03 |
| A10= | 1.82898681E−03 | −5.65459317E−04 | 1.2801999E−04 | 1.82015638E−04 |
| A12= | −3.68465906E−04 | 5.68515921E−05 | −1.1380258E−05 | −1.27176494E−05 |
| A14= | 4.52491201E−05 | −3.57238560E−06 | 7.0378787E−07 | 5.49758093E−07 |
| A16= | −3.26280147E−06 | 1.38350534E−07 | −2.7359096E−08 | −1.40032357E−08 |
| A18= | 1.26381863E−07 | −3.04214567E−09 | 5.9835582E−10 | 1.90586058E−10 |
| A20= | −2.02854858E−09 | 2.85156573E−11 | −5.6187468E−12 | −1.06836272E−12 |

In the 8th embodiment, the equation of the aspheric surface profiles of the aforementioned lens elements is the same as the equation of the 1st embodiment. Also, the definitions of these parameters shown in Table 8C are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Schematic Parameters

| | | | |
|---|---|---|---|
| f [mm] | 6.54 | T23/CT2 | 1.86 |
| Fno | 1.70 | T34/CT2 | 0.31 |
| HFOV [deg.] | 40.9 | T56/T45 | 6.58 |
| FOV [deg.] | 81.8 | V1-V2 | 37.7 |
| f/f1 | 1.15 | V4-V3 | 37.6 |
| f1/f45 | 0.14 | Dbs0/Ys0 | 0.48 |
| R11/R12 | 1.59 | (Y3R2-Y2R2)/(Y4R2-Y3R2) | 0.66 |
| R14/R13 | 2.34 | (Y5R1-Y4R2)/(Y6R1-Y5R2) | 0.51 |
| DbR1 [mm] | 0.09 | ET1/ET2 | 1.08 |
| DsR2/DbR2 | 0.27 | ET1/ET5 | 1.23 |
| CT1/ST1 | 2.76 | ST7/ST6 | 1.31 |
| CT2/CT1 | 0.23 | SAG3R1/SAG2R2 | −0.32 |
| CT3/CT1 | 0.27 | SAG3R2/SAG4R2 | 0.10 |
| CT4/CT1 | 0.41 | SAG5R1/CT5 | −0.40 |
| Ys0/ImgH | 0.33 | Ys0/Ybo | 0.96 |
| T12/CT3 | 0.15 | — | — |

### 9th Embodiment

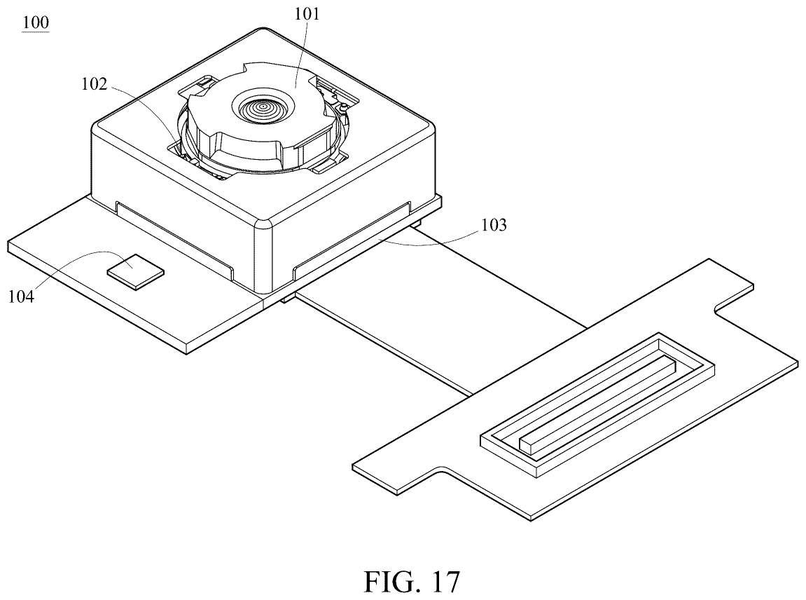

FIG. 17 is a perspective view of an image capturing unit according to the 9th embodiment of the present disclosure. In this embodiment, an image capturing unit 100 is a camera module including a lens unit 101, a driving device 102, an image sensor 103 and an image stabilizer 104. The lens unit 101 includes the optical photography lens system disclosed in the 1st embodiment and a holder member (its reference numeral is omitted) for holding the optical photography lens system. However, the lens unit 101 may alternatively be provided with the optical photography lens system disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems, or shape memory alloy materials. The driving device 102 is favorable for obtaining a better imaging position of the lens unit 101, so that a clear image of the imaged object can be captured by the lens unit 101 with different object distances. The image sensor 103 (for example, CCD or CMOS), which can feature high photosensitivity and low noise, is disposed on the image surface of the optical photography lens system to provide higher image quality.

The image stabilizer 104, such as an accelerometer, a gyro sensor and a Hall effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 10th Embodiment

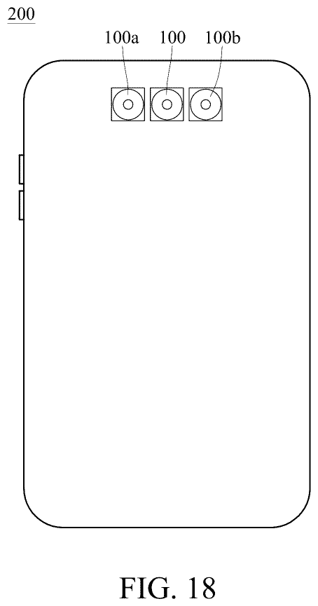

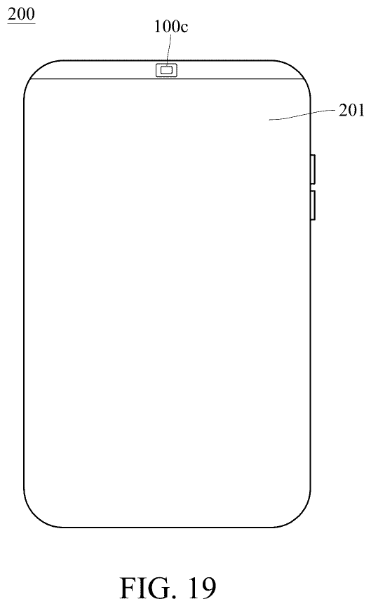

FIG. 18 is a perspective view of an electronic device according to the 10th embodiment of the present disclosure. FIG. 19 is another perspective view of the electronic device in FIG. 18.

In this embodiment, an electronic device 200 is a smartphone including the image capturing unit 100 disclosed in the 9th embodiment, an image capturing unit 100a, an image capturing unit 100b, an image capturing unit 100c and a display unit 201. As shown in FIG. 18, the image capturing unit 100, the image capturing unit 100a and the image capturing unit 100b are disposed on the same side of the electronic device 200 and face the same side, and each of the image capturing units 100, 100a and 100b has a single focal point. As shown in FIG. 19, the image capturing unit 100c and the display unit 201 are disposed on the opposite side of the electronic device 200, such that the image capturing unit 100c can be a front-facing camera of the electronic device 200 for taking selfies, but the present disclosure is not limited thereto. Furthermore, each of the image capturing units 100a, 100b and 100c can include the optical photography lens system of the present disclosure and can have a configuration similar to that of the image capturing unit 100. In detail, each of the image capturing units 100a, 100b and 100c can include a lens unit, a driving device, an image sensor and an image stabilizer, and each of the lens unit can include an optical photography lens system such as the optical photography lens system of the present disclosure and a holder member for holding the optical photography lens system.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 19, the image capturing unit 100c can have a non-circular opening, and the lens barrel or the lens elements in the image capturing unit 100c can have one or more trimmed edges at outer diameter positions thereof for corresponding to the non-circular opening. Therefore, it is favorable for further reducing the length of the image capturing unit 100c along single axis, thereby reducing the overall size of the lens, increasing the area ratio of the display unit 201 with respect to the electronic device 200, reducing the thickness of the electronic device 200, and achieving compactness of the overall module. In this embodiment, the electronic device 200 includes multiple image capturing units 100, 100a, 100b and 100c, but the present disclosure is not limited to the number and arrangement of image capturing units.

### 11th Embodiment

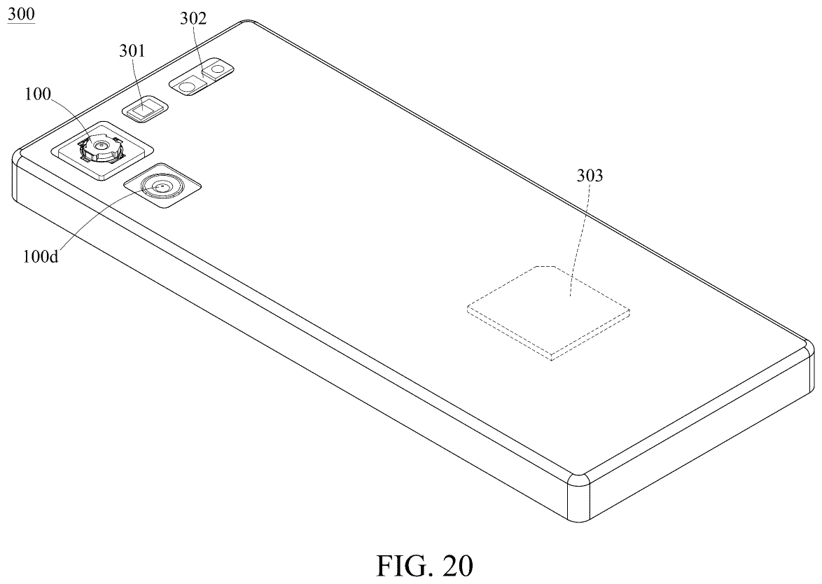

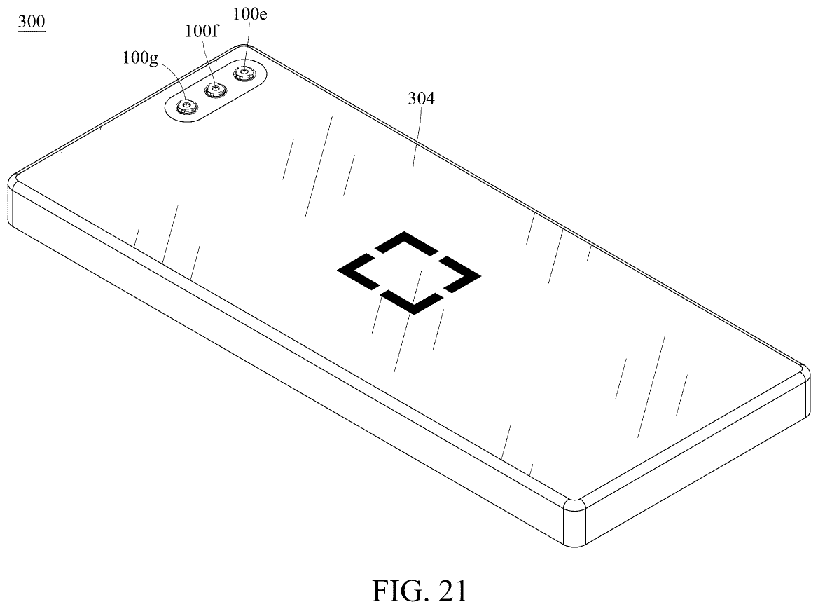

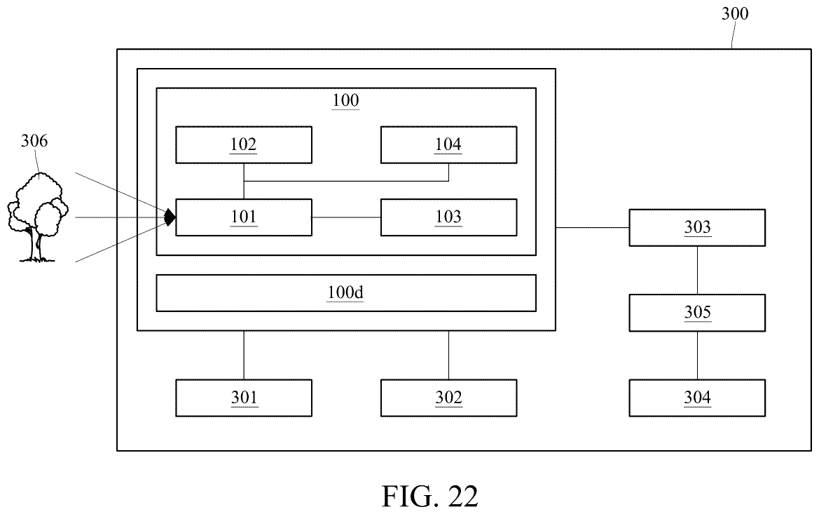

FIG. 20 is a perspective view of an electronic device according to the 11th embodiment of the present disclosure. FIG. 21 is another perspective view of the electronic device in FIG. 20. FIG. 22 is a block diagram of the electronic device in FIG. 20.

In this embodiment, an electronic device 300 is a smartphone including the image capturing unit 100 disclosed in the 9th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, the image capturing unit 100f, the image capturing unit 100g and the display module 304 are disposed on the opposite side of the electronic device 300, and the display module 304 can be a user interface, such that the image capturing units 100e, 100f, 100g can be front-facing cameras of the electronic device 300 for taking selfies, but the present disclosure is not limited thereto. Furthermore, each of the image capturing units 100d, 100e, 100f and 100g can include the optical photography lens system of the present disclosure and can have a configuration similar to that of the image capturing unit 100. In detail, each of the image capturing units 100d, 100e, 100f and 100g can include a lens unit, a driving device, an image sensor and an image stabilizer, and each of the lens unit can include an optical photography lens system such as the optical photography lens system of the present disclosure and a holder member for holding the optical photography lens system.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can determine depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 12th Embodiment

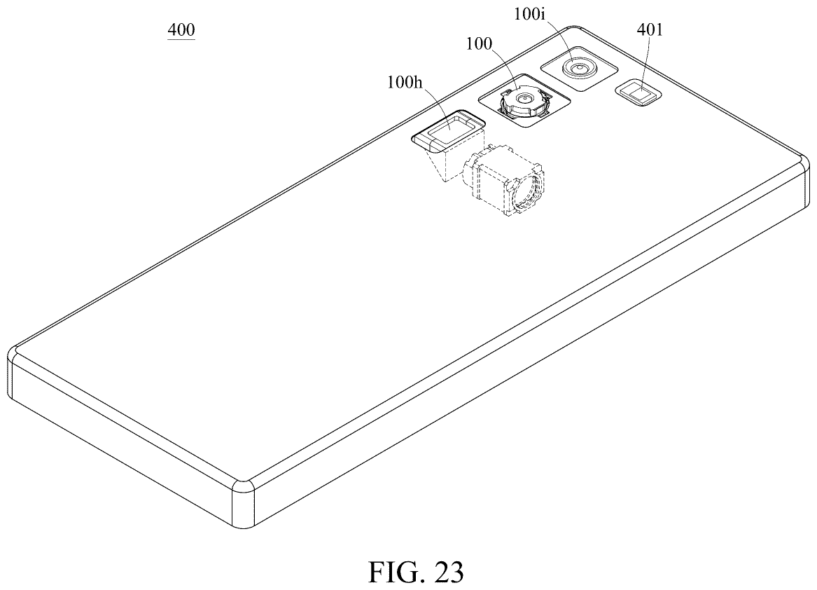

FIG. 23 is a perspective view of an electronic device according to the 12th embodiment of the present disclosure.

In this embodiment, an electronic device 400 is a smartphone including the image capturing unit 100 disclosed in the 9th embodiment, an image capturing unit 100h, an image capturing unit 100i, a flash module 401, a focus assist module, an image signal processor, a display module and an image software processor (not shown). The image capturing unit 100, the image capturing unit 100h and the image capturing unit 100i are disposed on the same side of the electronic device 400, while the display module is disposed on the opposite side of the electronic device 400. Furthermore, each of the image capturing units 100h and 100i can include the optical photography lens system of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. Moreover, the image capturing unit 100h can be a telephoto image capturing unit having a light-folding element configuration, such that the total track length of the image capturing unit 100h is not limited by the thickness of the electronic device 400. In this embodiment, the electronic device 400 includes multiple image capturing units 100, 100h and 100i, but the present disclosure is not limited to the number and arrangement of image capturing units. When a user captures images of an object, light rays converge in the image capturing unit 100, 100h or 100i to generate images, and the flash module 401 is activated for light supplement. Further, the subsequent processes are performed in a manner similar to the abovementioned embodiment, so the details in this regard will not be provided again.

### 13th Embodiment

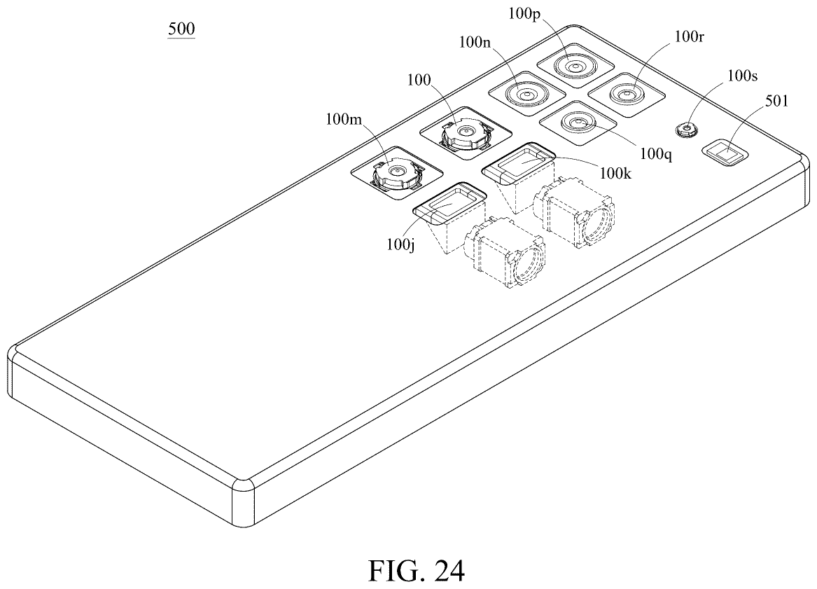

FIG. 24 is a perspective view of an electronic device according to the 13th embodiment of the present disclosure.

In this embodiment, an electronic device 500 is a smartphone including the image capturing unit 100 disclosed in the 9th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the optical photography lens system of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. Moreover, each of the image capturing units 100j and 100k can be a telephoto image capturing unit having a light-folding element configuration. In addition, the image capturing unit 100s can determine depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

The smartphone in several embodiments is only exemplary for showing the image capturing unit of the present disclosure installed in an electronic device, and the present disclosure is not limited thereto. The image capturing unit can be optionally applied to optical systems with a movable focus. Furthermore, the optical photography lens system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that TABLES 1A-8C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical photography lens system comprising a lens barrel and a plurality of lens elements disposed in the lens barrel;
wherein a total number of the plurality of lens elements is six, seven, or eight;
when the total number of the plurality of lens elements is six, the plurality of lens elements are, in order from an object side to an image side along an optical path, a first lens element, a second lens element, a third lens element, a fourth lens element, a fifth lens element and a sixth lens element;
when the total number of the plurality of lens elements is seven, the plurality of lens elements are, in order from the object side to the image side along the optical path, the first lens element, the second lens element, the third lens element, the fourth lens element, the fifth lens element, the sixth lens element and a seventh lens element;
when the total number of the plurality of lens elements is eight, the plurality of lens elements are, in order from the object side to the image side along the optical path, the first lens element, the second lens element, the third lens element, the fourth lens element, the fifth lens element, the sixth lens element, the seventh lens element and an eighth lens element;
wherein each of the plurality of lens elements has an object-side surface facing toward the object side and an image-side surface facing toward the image side;
wherein at least one of the object-side surface and the image-side surface of at least one lens element of the optical photography lens system has at least one inflection point;
wherein the optical photography lens system further comprises a light-blocking element located in the lens barrel and located on an object side of the first lens element;
wherein the light-blocking element has an object-side surface facing towards the object side, an image-side surface facing towards the image side and a minimum opening located between the object-side surface and the image-side surface of the light-blocking element;
wherein the lens barrel has a lens-barrel-minimum-opening located on an object side of the minimum opening of the light-blocking element;
wherein a central thickness of the first lens element is CT1, a lens thickness of the first lens element in parallel with an optical axis at a maximum effective radius position of the minimum opening of the light-blocking element is ST1, and the following condition is satisfied:
$$1.1 < CT 1 / ST 1 < 3.00 .$$

2. The optical photography lens system of claim 1, wherein a displacement in parallel with the optical axis from a most-object-end of the lens barrel to an axial vertex on the object-side surface of the first lens element is DbR1, a displacement in parallel with the optical axis from the most-object-end of the lens barrel to a most-object-end of the light-blocking element is Dbs0, a maximum effective radius of the minimum opening of the light-blocking element is Ys0, and the following conditions are satisfied:
$$- 0 \text{.10} mm < DbR 1 ; and$$
$$0.15 < Dbs 0 / Ys 0 < 0.80 .$$

3. The optical photography lens system of claim 1, wherein the first lens element has positive refractive power, the object-side surface of the first lens element is convex in a paraxial region thereof, and the object-side surface of the sixth lens element has at least one critical point in an off-axis region thereof;
wherein the lens barrel is made of plastic material, and each of the fifth lens element and the sixth lens element is made of plastic material;
wherein half of a maximum field of view of the optical photography lens system is HFOV, and the following condition is satisfied:
$$25. degrees < HFOV < 50. degrees$$

4. The optical photography lens system of claim 2, wherein an Abbe number of the first lens element is V1, an Abbe number of the second lens element is V2, an Abbe number of the third lens element is V3, an Abbe number of the fourth lens element is V4, and the following conditions are satisfied:
$$15. < V 1 - V 2 < 52. ; and$$
$$25. < V 4 - V 3 < 52.0 .$$

5. The optical photography lens system of claim 2, wherein the optical photography lens system further comprises another light-blocking element located between the second lens element and the third lens element;
wherein an axial distance between the second lens element and the third lens element is T23, a central thickness of the second lens element is CT2, and the following condition is satisfied:
$$1. < T 23 / CT 2 < 3.20 .$$

6. The optical photography lens system of claim 1, wherein a displacement in parallel with the optical axis from a most-object-end of the lens barrel to an axial vertex on the object-side surface of the first lens element is DbR1, a focal length of the optical photography lens system is f, a focal length of the first lens element is f1, and the following conditions are satisfied:
$$0 mm \leq DbR 1 < 0.4 mm ; and$$
$$0.4 < f / f 1 < 1.5 0 .$$

7. The optical photography lens system of claim 1, wherein at least one of the object-side surface and the image-side surface of at least one lens element of the optical photography lens system has at least one critical point in an off-axis region thereof;
wherein the central thickness of the first lens element is CT1, the lens thickness of the first lens element in parallel with the optical axis at the maximum effective radius position of the minimum opening of the light-blocking element is ST1, and the following condition is satisfied:
$$1.2 < CT 1 / ST 1 < 2.80 .$$

8. The optical photography lens system of claim 1, wherein an f-number of the optical photography lens system is Fno, a maximum effective radius of the minimum opening of the light-blocking element is Ys0, a maximum effective radius of the lens-barrel-minimum-opening of the lens barrel is Ybo, and the following conditions are satisfied:
$$1.45 < Fno < 1.9 ; and$$
$$0.95 < Ys 0 / Ybo < 1.05 .$$

9. The optical photography lens system of claim 6, wherein the central thickness of the first lens element is CT1, a central thickness of the second lens element is CT2, a central thickness of the fourth lens element is CT4, and the following conditions are satisfied:
$$0.1 < CT 2 / CT 1 < 0.4 ; and$$
$$0.3 < CT 4 / CT 1 < 1.00 .$$

10. The optical photography lens system of claim 6, wherein an axial distance between the first lens element and the second lens element is T12, a central thickness of the third lens element is CT3, the focal length of the first lens element is f1, a composite focal length of the fourth lens element and the fifth lens element is f45, and the following conditions are satisfied:
$$0 \leq T 12 / CT 3 < 1. ; and$$
$$- 0.5 < f 1 / f 45 < 1. .$$

11. The optical photography lens system of claim 1, wherein a displacement in parallel with the optical axis from an axial vertex on the image-side surface of the second lens element to a maximum effective radius position on the image-side surface of the second lens element is SAG2R2, a displacement in parallel with the optical axis from an axial vertex on the object-side surface of the third lens element to a maximum effective radius position on the object-side surface of the third lens element is SAG3R1, and the following condition is satisfied:
$$- 1.7 < SAG 3 R 1 / SAG 2 R 2 < - 0.25 .$$

12. The optical photography lens system of claim 1, wherein a maximum effective radius of the image-side surface of the second lens element is Y2R2, a maximum effective radius of the image-side surface of the third lens element is Y3R2, a maximum effective radius of the image-side surface of the fourth lens element is Y4R2, a displacement in parallel with the optical axis from an axial vertex on the image-side surface of the third lens element to a maximum effective radius position on the image-side surface of the third lens element is SAG3R2, a displacement in parallel with the optical axis from an axial vertex on the image-side surface of the fourth lens element to a maximum effective radius position on the image-side surface of the fourth lens element is SAG4R2, and the following conditions are satisfied:
$$- 0.1 < ( Y 3 R 2 - Y 2 R 2 ) / ( Y 4 R 2 - Y 3 R 2 ) < 1.2 ; and$$
$$0 < SAG 3 R 2 / SAG 4 R 2 < 0.6 .$$

13. The optical photography lens system of claim 1, wherein the central thickness of the first lens element is CT1, a central thickness of the third lens element is CT3, a maximum effective radius of the minimum opening of the light-blocking element is Ys0, a maximum image height of the optical photography lens system is ImgH, and the following conditions are satisfied:
$$0.1 < CT 3 / CT 1 < 0.55 ; and$$
$$0.1 < Ys 0 / ImgH < 0.5 .$$

14. The optical photography lens system of claim 1, wherein a displacement in parallel with the optical axis from a most-object-end of the lens barrel to an axial vertex on the object-side surface of the first lens element is DbR1, a displacement in parallel with the optical axis from the most-object-end of the lens barrel to an axial vertex on the image-side surface of the first lens element is DbR2, the central thickness of the first lens element is CT1, the lens thickness of the first lens element in parallel with the optical axis at the maximum effective radius position of the minimum opening of the light-blocking element is ST1, a displacement in parallel with the optical axis from a most-object-end of the light-blocking element to the axial vertex on the image-side surface of the first lens element is DsR2, a displacement in parallel with the optical axis from the most-object-end of the lens barrel to the most-object-end of the light-blocking element is Dbs0, a maximum effective radius of the minimum opening of the light-blocking element is Ys0, an f-number of the optical photography lens system is Fno, half of a maximum field of view of the optical photography lens system is HFOV, and the following conditions are satisfied:
$$0.01 mm \leq DbR 1 < 0.34 mm ;$$
$$1.56 \leq CT 1 / ST 1 \leq 2.95 ;$$
$$0.27 \leq DsR 2 / DbR 2 \leq 0.57 ;$$
$$0.35 \leq Dbs 0 / Ys 0 \leq 0.69 ;$$
$$1.52 \leq Fno \leq 1.84 ; and$$
$$36.4 degrees \leq HFOV \leq 45.3 degrees .$$

15. An image capturing unit, comprising:
the optical photography lens system of claim 1; and
an image sensor disposed on an image surface of the optical photography lens system.

16. An optical photography lens system comprising a lens barrel and seven lens elements disposed in the lens barrel, the seven lens elements being, in order from an object side to an image side along an optical path, a first lens element, a second lens element, a third lens element, a fourth lens element, a fifth lens element, a sixth lens element and a seventh lens element, and each of the seven lens elements having an object-side surface facing toward the object side and an image-side surface facing toward the image side;
wherein the first lens element has positive refractive power, the object-side surface of the first lens element is convex in paraxial region thereof, the seventh lens element has negative refractive power, and the image-side surface of the seventh lens element is concave in a paraxial region thereof;
wherein the optical photography lens system further comprises a light-blocking element located in the lens barrel and located on an object side of the first lens element, and the light-blocking element has an object-side surface facing towards the object side, an image-side surface facing towards the image side, and a minimum opening located between the object-side surface and the image-side surface of the light-blocking element;
wherein the lens barrel has a lens-barrel-minimum-opening located on an object side of the minimum opening of the light-blocking element;
wherein a central thickness of the first lens element is CT1, a lens thickness of the first lens element in parallel with an optical axis at a maximum effective radius position of the minimum opening of the light-blocking element is ST1, and the following condition is satisfied:
$$1.3 < CT 1 / ST 1 < 2.6 .$$

17. The optical photography lens system of claim 16, wherein a displacement in parallel with the optical axis from a most-object-end of the light-blocking element to an axial vertex on the image-side surface of the first lens element is DsR2, a displacement in parallel with the optical axis from a most-object-end of the lens barrel to the axial vertex on the image-side surface of the first lens element is DbR2, and the following condition is satisfied:
$$0.05 < DsR 2 / DbR 2 < 0.9 .$$

18. The optical photography lens system of claim 17, wherein a lens thickness of the sixth lens element in parallel with the optical axis at the maximum effective radius position of the minimum opening of the light-blocking element is ST6, a lens thickness of the seventh lens element in parallel with the optical axis at the maximum effective radius position of the minimum opening of the light-blocking element is ST7, a curvature radius of the object-side surface of the seventh lens element is R13, a curvature radius of the image-side surface of the seventh lens element is R14, and the following conditions are satisfied:
$$1.8 < ST 7 / ST 6 < 3.6 ; and$$
$$- 1. < R 14 / R 13 < 0.1 .$$

19. The optical photography lens system of claim 16, wherein the seventh lens element is made of plastic material;
wherein a displacement in parallel with the optical axis from a most-object-end of the lens barrel to a most-object-end of the light-blocking element is Dbs0, a maximum effective radius of the minimum opening of the light-blocking element is Ys0, and the following condition is satisfied:
$$0.25 < Dbs 0 / Ys 0 < 0.6 .$$

20. The optical photography lens system of claim 19, wherein an axial distance between the second lens element and the third lens element is T23, an axial distance between the third lens element and the fourth lens element is T34, a central thickness of the second lens element is CT2, and the following conditions are satisfied:
$$0 \leq T 34 / CT 2 < 1. ; and$$
$$2. < T 23 / CT 2 < 2.9 .$$

21. The optical photography lens system of claim 16, wherein the image-side surface of the second lens element is concave in a paraxial region thereof, the image-side surface of the fifth lens element is concave in a paraxial region thereof, the sixth lens element has negative refractive power, the object-side surface of the sixth lens element is convex in a paraxial region thereof, the object-side surface of the seventh lens element is concave in a paraxial region thereof, and the image-side surface of the seventh lens element has at least one critical point in an off-axis region thereof.

22. The optical photography lens system of claim 16, wherein a displacement in parallel with the optical axis from a most-object-end of the lens barrel to an axial vertex on the object-side surface of the first lens element is DbR1, a curvature radius of the object-side surface of the sixth lens element is R11, a curvature radius of the image-side surface of the sixth lens element is R12, and the following conditions are satisfied:
$$- 0.05 mm < DbR 1 < 0.5 mm ; and$$
$$- 1. < R 11 / R 12 < 0.2 .$$

23. The optical photography lens system of claim 22, wherein a maximum effective radius of the image-side surface of the fourth lens element is Y4R2, a maximum effective radius of the object-side surface of the fifth lens element is Y5R1, a maximum effective radius of the image-side surface of the fifth lens element is Y5R2, a maximum effective radius of the object-side surface of the sixth lens element is Y6R1, and the following condition is satisfied:
$$0.3 < ( Y 5 R 1 - Y 4 R 2 ) / ( Y 6 R 1 - Y 5 R 2 ) < 1.3 .$$

24. The optical photography lens system of claim 16, wherein the image-side surface of the fifth lens element has at least one inflection point;
wherein a distance in parallel with the optical axis between a maximum effective radius position of the object-side surface of the first lens element and a maximum effective radius position of the image-side surface of the first lens element is ET1, a distance in parallel with the optical axis between a maximum effective radius position of the object-side surface of the fifth lens element and a maximum effective radius position of the image-side surface of the fifth lens element is ET5, and the following condition is satisfied:
$$0.8 < ET 1 / ET 5 < 2. .$$

25. The optical photography lens system of claim 24, wherein an axial distance between the fourth lens element and the fifth lens element is T45, an axial distance between the fifth lens element and the sixth lens element is T56, a displacement in parallel with the optical axis from an axial vertex on the object-side surface of the fifth lens element to a maximum effective radius position on the object-side surface of the fifth lens element is SAG5R1, a central thickness of the fifth lens element is CT5, and the following conditions are satisfied:
$$0.05 < T 56 / T 45 < 1. ; and$$
$$- 1.8 < SAG 5 R 1 / CT 5 < - 0.5 .$$

26. The optical photography lens system of claim 16, wherein a distance in parallel with the optical axis between a maximum effective radius position of the object-side surface of the first lens element and a maximum effective radius position of the image-side surface of the first lens element is ET1, a distance in parallel with the optical axis between a maximum effective radius position of the object-side surface of the second lens element and a maximum effective radius position of the image-side surface of the second lens element is ET2, and the following condition is satisfied:
$$1. < ET 1 / ET 2 < 3. .$$

27. An electronic device comprising an image capturing unit which comprises:
the optical photography lens system of claim 16; and
an image sensor disposed on an image surface of the optical photography lens system.
